(19) United States
(12) Patent Application Publication
(10) Pub. No.: US 2012/0040703 A1
(43) Pub. Date: Feb. 16, 2012

(54) BROADCASTING METHOD, ACCESS CONTROL APPARATUS AND RADIO APPARATUS

(76) Inventors: Kunihiro Kawase, Gifu (JP); Ken Nakaoka, Aichi (JP); Hanae Suzuki, Gifu (JP); Yoshiyuki Otani, Gifu (JP)

(21) Appl. No.: 13/147,332

(22) PCT Filed: Jan. 28, 2010
(86) PCT No.: PCT/JP2010/000519

§ 371 Date: Oct. 28, 2011

(30) Foreign Application Priority Data
Jan. 30, 2009 (JP) 2009-020971
Jan. 30, 2009 (JP) 2009-020973

(51) Int. Cl. H04W 56/00

(52) U.S. Cl. 455/502

(57) ABSTRACT

A processing unit generates timing information on timing, with which each of radio apparatuses is to synchronize in communication between the radio apparatuses when each of the radio apparatus broadcasts a signal, to control the communication between the radio apparatuses. A modem unit and the like broadcast the thus generated timing information. An RF unit and the like receive a signal which is synchronous with the timing information broadcast by them. When a signal which is asynchronous with the timing information and when the duration of this signal continues for a period longer than a first threshold value and the quality of this signal is more deteriorated than a second threshold value, a decision unit detects that the received signal is a disturbing signal. The modem unit and the like also broadcast to the effect that the disturbing signal has been detected.

### TECHNICAL FIELD

The present invention relates to a broadcasting technology and, more particularly, to a broadcasting method for sending signals containing predetermined information, an access control apparatus, and a radio apparatus.

### BACKGROUND TECHNOLOGY

Road-to-vehicle communication has been under investigation in an effort to prevent collision accidents of vehicles on a sudden encounter at an intersection. In a road-to-vehicle communication, information on conditions at an intersection is communicated between a roadside unit and an in-vehicle unit. Such a road-to-vehicle communication requires installation of roadside units, which means a great cost of time and money. In contrast to this, a vehicle-to-vehicle (inter-vehicular) communication, in which information is communicated between in-vehicle units, has no need for installation of roadside units. In that case, current position information is detected in real time by GPS (Global Positioning System) or the like and the position information is exchanged between the in-vehicle units. Thus it is determined on which of the roads leading to the intersection the driver's vehicle and the other vehicles are located (See Patent Document 1, for instance).

### PRIOR ART DOCUMENTS

### Patent Documents

[Patent Document 1] Japanese Unexamined Patent Application Publication No. 2005-202913.

### DISCLOSURE OF THE INVENTION

### Problems to be Solved by the Invention

Used in wireless LANs (Local Area Networks) conforming to standards, such as IEEE 802.11, is an access control function called Carrier Sense Multiple Access with Collision Avoidance (CSMA/CA). In such a wireless LAN, therefore, the same wireless channel is shared by a plurality of terminal apparatuses. Such CSMA/CA is subject to conditions involving mutual wireless signals not reaching the targets, namely, carrier sense not functioning, due to the effects of distance between the terminal apparatuses or obstacles attenuating the radio waves and so forth. When the carrier sense does not function, there occur collisions of packet signals transmitted from a plurality of terminal apparatuses. Also, wireless LANs employ the OFDM modulation scheme to achieve faster communication speed.

On the other hand, when a wireless LAN is applied to the inter-vehicular communication, a need arises to transmit information to a large indefinite number of terminal apparatuses, and therefore it is desirable that signals be sent by broadcast. Yet, at an intersection or like places, an increase in the number of vehicles, that is, the number of terminal apparatuses, is considered to cause an increase in the collisions of the packet signals therefrom. In consequence, data contained in the packet signals may not be transmitted to the other terminal apparatuses. If such a condition occurs in the inter-vehicular communication, then the objective of preventing collision accidents of vehicles on a sudden encounter at an intersection will not be attained. On the other hand, even though a prescription, definition, protocol, specification or regulation is provided to achieve such an objective, the objective thereof will not be eventually attained when the communication is less likely to be achieve because of the existence of disturbing signals.

The present invention has been made in view of the foregoing circumstances, and a purpose thereof is to provide a technology for reducing the influence by the disturbing signals.

### Means for Solving the Problems

In order to resolve the above problems, an access control apparatus according to one embodiment of the present invention includes: a processing unit configured to generate timing information on timing, with which each of radio apparatuses is to synchronize when the each of radio apparatus broadcasts a signal, to control the communication between the radio apparatuses; a broadcasting unit configured to broadcast the timing information generated by the processing unit; and a receiver configured to receive a signal used in the communication between the radio apparatuses, the signal being synchronous with the timing information broadcast by the broadcasting unit. When the receiver has received a signal which is asynchronous with the timing information and when the duration of said signal continues for a period longer than a first threshold value and the quality of said signal is more deteriorated than a second threshold value, the processing unit may detect that the signal received by the receiver is a disturbing signal; and the broadcasting unit may further broadcast a detection result that the disturbing signal has been detected by the processing unit.

Another embodiment of the present invention relates to a broadcasting method. This method includes: broadcasting timing information on timing, with which each of radio apparatuses is to synchronize when the each of radio apparatus broadcasts a signal, to control the communication between the radio apparatuses; receiving a signal used in the communication between the radio apparatuses, the signal being synchronous with the timing information broadcast by the broadcasting; and detecting that the received signal is a disturbing signal, when a signal which is asynchronous with the timing information has been received and when the duration of said signal continues for a period longer than a first threshold value and the quality of said signal is more deteriorated than a second threshold value. The broadcasting may further broadcast a detection result that the disturbing signal has been detected.

Optional combinations of the aforementioned constituting elements, and implementations of the invention in the form of methods, apparatuses, systems, recording media, computer programs and so forth may also be practiced as additional modes of the present invention.

### EFFECT OF THE INVENTION

The present invention reduces the influence by disturbing signals.

### BRIEF DESCRIPTION OF THE DRAWINGS

FIG. 1 shows a structure of a communication system according to an exemplary embodiment of the present invention.

FIG. 2 shows a structure of an access control apparatus of FIG. 1.

FIGS. 3A to 3D show formats of frames generated by a frame generator of FIG. 2.

FIGS. 4A and 4B show formats of OFDM symbol used in the communication system of FIG. 1.

FIG. 5 shows a structure of a terminal apparatus mounted on a vehicle of FIG. 1.

FIG. 6 shows an operational overview of the communication system of FIG. 1.

FIG. 7 is a flowchart showing a procedure in which control information is broadcast by the access control apparatus of FIG. 2.

FIG. 8 is a flowchart showing a procedure in which degradation information is deterred by the access control apparatus of FIG. 2.

FIG. 9 is a flowchart showing a procedure in which data is broadcast by the terminal apparatus of FIG. 5.

FIG. 10 shows a structure of an access control apparatus according to a modification.

FIG. 11 shows an operational overview of a communication system according to a modification.

FIG. 12 is a flowchart showing a procedure in which an empty slot is notified by the access control apparatus of FIG. 10.

FIG. 13 is a flowchart showing a procedure in which a collision slot is notified by the access control apparatus of FIG. 10.

FIG. 14 is a flowchart showing a procedure in which data is transmitted by a terminal apparatus according to a modification.

FIG. 15 shows a structure of a communication system according to another modification.

FIG. 16 shows a structure of a control access control apparatus of FIG. 15.

FIGS. 17A to 17D show formats of frames generated by a frame generator of FIG. 16.

FIGS. 18A and 18B show formats of OFDM symbol used in the communication system of FIG. 15.

FIG. 19 shows a structure of a terminal apparatus mounted on a vehicle of FIG. 15.

FIG. 20 shows an operational overview of the communication system of FIG. 15.

FIG. 21 is a flowchart showing a procedure in which control information is broadcast by the access control apparatus of FIG. 2.

FIG. 22 is a flowchart showing a procedure in which data is broadcast by the terminal apparatus of FIG. 19.

FIG. 23 is a flowchart showing a procedure in which degradation information is stored by the terminal apparatus of FIG. 19.

FIG. 24 is a flowchart showing a procedure in which degradation information is managed by the terminal apparatus of FIG. 19.

FIG. 25 is a flowchart showing another procedure in which degradation information is managed by the terminal apparatus of FIG. 19.

FIG. 26 is a flowchart showing still another procedure in which degradation information is managed by the terminal apparatus of FIG. 19.

FIG. 27 shows a structure of an access control apparatus according to still another modification.

FIG. 28 shows an operational overview of a communication system according to still another modification.

FIG. 29 is a flowchart showing a procedure in which an empty slot is notified by the access control apparatus of FIG. 27.

FIG. 30 is a flowchart showing a procedure in which a collision slot is notified by the access control apparatus of FIG. 27.

FIG. 31 is a flowchart showing a procedure in which data is transmitted by a terminal apparatus according to still another modification.

### BEST MODE FOR CARRYING OUT THE INVENTION

The present invention will be outlined before it is explained in detail. Exemplary embodiments of the present invention relate to a communication system carrying out data communication between terminal apparatuses installed in vehicles. A terminal apparatus transmits, by broadcast, packet signals containing information such as the traveling speed and position of a vehicle (hereinafter referred to as “data”). And the other terminal apparatuses receive the packet signals and recognize the approach or the like of the vehicle based on the data. Note here that the terminal apparatuses employ the OFDM modulation scheme to achieve faster communication speed. Under these circumstances, an increase in the number of terminal apparatuses at an intersection or like place increases the probability of packet signals occurring. To cope with it, the communication system according to the present exemplary embodiment executes the following processes.

The communication system according to the present exemplary embodiment includes an access control apparatus in addition to a plurality of terminal apparatuses, and the access control apparatus is installed at an intersection, for instance. The access control apparatus repeatedly specifies a frame containing a plurality of slots. Note that one or more of the plurality of slots contained in each frame are reserved and secured as control slots. Also, the access control apparatus identifies control slots to be used, and adds information on timings of the control slots and information with which to identify said access apparatus (hereinafter referred to as “identification information) to control information. Also, the access control apparatus transmits, by broadcast, a packet signal containing the control information (hereinafter referred to sometimes as “control information” also) using the control slots. Here, the information on timings of the control slots is, for instance, information on which slot number, starting from the beginning of a frame, the control slot is assigned to (this information will be referred to as “control slot information”).

A terminal apparatus receives the control information and thereby generates a frame corresponding to the control information. The thus generated frame contains a plurality of slots as well. Also, the terminal apparatus recognizes slots, in the plurality of slots contained in the frame, which are other than the control slots. Note that in the description of terminal apparatuses given hereunder the slots sometimes mean those excluding the control slots. Each terminal apparatus performs carrier sensing on a plurality of slots, respectively, and thereby it estimates a slot which is not used by other terminal terminals (hereinafter referred to as “empty slot” or “unused slot”). There may be a plurality of such empty slots. The terminal apparatus selects at random one slot to be used for the transmission of data from among empty slots. The terminal apparatus transmits, by broadcast, a packet signal containing data (hereinafter referred to sometimes as “data” also) using the selected slot. The terminal apparatus uses a relatively identical slot for a plurality of frames.

Note here that the access control apparatus has no direct involvement in data communication between terminal apparatuses, that is, the access control apparatus does not directly specify the slot to be used in the data communication. In other words, the access control apparatus only conveys the construction of a frame containing slots to be used by a plurality of terminal apparatus. The terminal apparatus performs data communication with timings of slots contained in the frame notified by the access control apparatus. That is, the access control apparatus controls the communications between a plurality of terminal apparatuses.

It is to be noted that since the control information is also transmitted in a single slot, there are chances that the data transmitted from a terminal apparatus incapable of receiving the control information may collide with the control information. In consequence, if the other terminal apparatuses cannot receive the control information, then there arises a difficulty of carrying out the aforementioned processes. To cope with this situation, the OFDM signals used in transmitting data have some of the subcarriers as null carriers in which no data is contained (these subcarriers being hereinafter referred to as “identification carriers”). On the other hand, the OFDM signals used in transmitting control information have signals placed in the identification carriers, too. Hence, even when there is a collision between data and control information, the terminal apparatus can detect the presence of control information by observing the signal components of the identification carrier.

Further, if a plurality of access apparatuses are installed at an intersection where they are located close to each other, interference between them must be taken into consideration. If, for instance, the control information transmitted by broadcast from the plurality of access control apparatuses interfere with each other, the terminal apparatuses may not be able to receive the control information and therefore the aforementioned operations will not be achieved. Though such interference can be avoided by assigning a different frequency channel to each access control apparatus, another separate structure to reduce the interference will be needed if no other frequency channel can be provided. To cope with this, a plurality of control slots are reserved and secured as described above. Each access control apparatus performs carrier sensing on a plurality of control slots, respectively, and thereby it selects one control slot and transmits, by broadcast, the control information using the selected control slot.

Even in such a case as defined above, there may be cases where disturbing signals are outputted in a frequency band overlapped in part or whole with the frequency band being used by the communication system. The disturbing signal meant herein is a signal which is not complied with the regulations and protocols in the aforementioned communication system. Here, “being overlapped” means either that the frequency band overlaps with a part of the frequency band used by the communication system or that it overlaps entirely with the frequency band used by the communication band. As a result, it is difficult to acquire the present positions of other vehicles. For example, even though the presence of another vehicle entering from intersecting roads is not notified to a driver from the communication system while the driver enter an intersection, the another vehicle is actually entering the intersection. In order to reduce this risk, when the access control apparatus detects the disturbing signal, the access control apparatus broadcasts the control information by adding the detection result indicating that the disturbing signal has been detected, the detected location and so forth to the control information. Terminal apparatuses that have received this information recognize the presence of the disturbing signal and notifies their drivers accordingly.

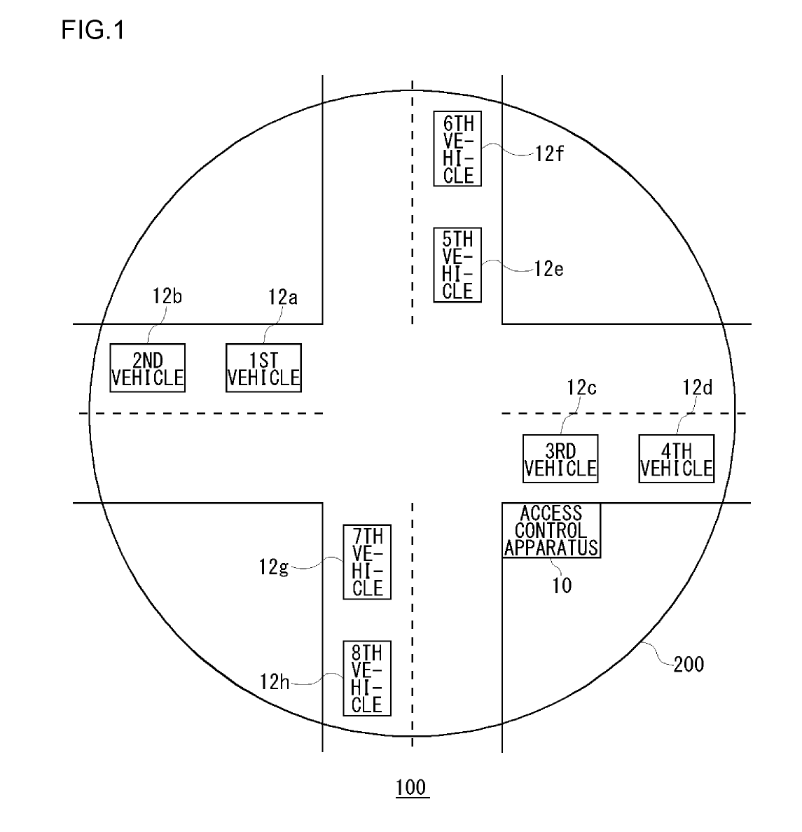

FIG. 1 shows a structure of a communication system 100 according to an exemplary embodiment of the present invention. FIG. 1 corresponds to a case thereof at an intersection viewed from above. The communication system 100 includes an access control apparatus 10 and a first vehicle 12a, a second vehicle 12b, a third vehicle 12c, a fourth vehicle 12d, a fifth vehicle 12e, a sixth vehicle 12f, a seventh vehicle 12g, and an eighth vehicle 12h, which are generically referred to as “vehicle 12” or “vehicles 12”. It is to be noted that each vehicle 12 has a not-shown terminal apparatus installed therein. Also, an area 200 is formed by the access control apparatus 10.

As shown in FIG. 1, a road extending in the horizontal, or left-right, direction and a road extending in the vertical, or up-down, direction in FIG. 1 intersect with each other in the central portion thereof. Note here that the upper side of FIG. 1 corresponds to the north, the left side thereof the west, the down side thereof the south, and the right side thereof the east. And the portion where the two roads intersect each other is the intersection. The first vehicle 12a and the second vehicle 12b are advancing from left to right, while the third vehicle 12c and the fourth vehicle 12d are advancing from right to left. Also, the fifth vehicle 12e and the sixth vehicle 12f are advancing downward, while the seventh vehicle 12g and the eighth vehicle 12h are advancing upward.

The terminal apparatus installed in each of the vehicles 12 acquires data and transmits, by broadcast, a packet signal containing the data. Here, before explaining exemplary embodiments of the present invention, a description will be given of an operation of a terminal apparatus which is compatible with a known wireless LAN, i.e., CSMA/CA. Each terminal apparatus transmits data by broadcast when it has determined by executing carrier sense that transmission is possible. Consequently, there are chances of data from a plurality of terminal apparatuses colliding with each other. Also, as the number of terminal apparatuses increases, there will be greater probability of collisions occurring. In particular, at locations like intersections, the likelihood of data collision is greater despite the fact that the likelihood of vehicles 12 colliding with each other is also great. This means failed utilization of data in spots where data is in the greatest demand.

Therefore, the communication system 100 places an access control apparatus 10 at each intersection. The access control apparatus 10 repeatedly generates a frame containing a plurality of slots, based on the signals received from not-shown GPS satellites. Here, one or more of the plurality of slots correspond to the control slots. The access control apparatus 10 adds the control slot information and the identification information to the control information. Further, the access control apparatus 10 broadcasts the control information, using control slots. The selection of the control slot(s) will be discussed later.

A plurality of terminal apparatuses receive the control information broadcast by the access control apparatus 10 and generate frames based on the control information. As a result, the frame generated by each of the plurality of terminal apparatuses is synchronized with the frame generated by the access control apparatus 10. Also, slots generated by the respective plurality of terminal apparatuses are synchronized with each other. Each terminal apparatus performs carrier sensing in a plurality of slots, respectively, and estimates empty slots. Also, the terminal apparatus randomly selects one slot out of the empty slots. Also, the terminal apparatus broadcasts data using the selected slot. The terminal apparatus continues to select the same slots in corresponding timing in each frame, for a plurality of frames. It is to be appreciated that the terminal apparatus may broadcast data even when the terminal apparatus is not receiving control information. The terminal apparatus which has received data from the other terminal apparatuses recognizes, based on the data, the presence of vehicles 12 that are carrying the other terminal apparatuses.

Note here that both the control information broadcast from the access control apparatus 10 and the data broadcast from the terminal apparatuses use OFDM signals. However, it is not the same subcarriers in which the control information and the data are placed. The data is not placed in the aforementioned identification carriers. On the other hand, identification information is placed not only in the subcarriers where the data is placed but also in the identification carriers. As a result, even when there is a collision between data and identification information, the terminal apparatus can detect the presence of control information by observing the signal components of identification carriers. It should be noted that the aforementioned detection of entry into the area 200 by the terminal apparatus may be made relative to the identification carriers.

Assume in FIG. 1 that a not-shown apparatus is installed in the area 200 and the disturbing signal is outputted from this apparatus. As described above, the frequency band of the disturbing signal overlaps in part or whole with the frequency band used by the communication system 100. The disturbing signal is outputted regardless of the timings of the frames and slots and it is being outputted for a long period of time over a plurality of frames, for instance. There may be cases where the control information and/or data in the communication system 100 are not received due to the presence of the disturbing signal. Assume, for example, that the terminal apparatus installed in the first vehicle 12a does not receive data sent from the fifth vehicle 12e. As a result, the drive of the first vehicle 12a is not notified of the presence of the fifth vehicle 12e. To cope with such a situation as this, the access control apparatus 10 detects whether the signal is a disturbing signal or not, based on the received signals. If it is a disturbing signal, the access control apparatus 10 will broadcast the control information by adding the detection result that the disturbing signals has been detected and the detection location to the control information. A terminal apparatus that have received this information recognizes the presence of the disturbing signal and notifies the driver of the presence of the disturbing signal. A method for determining whether the received signal is a disturbing signal or not will be discussed later.

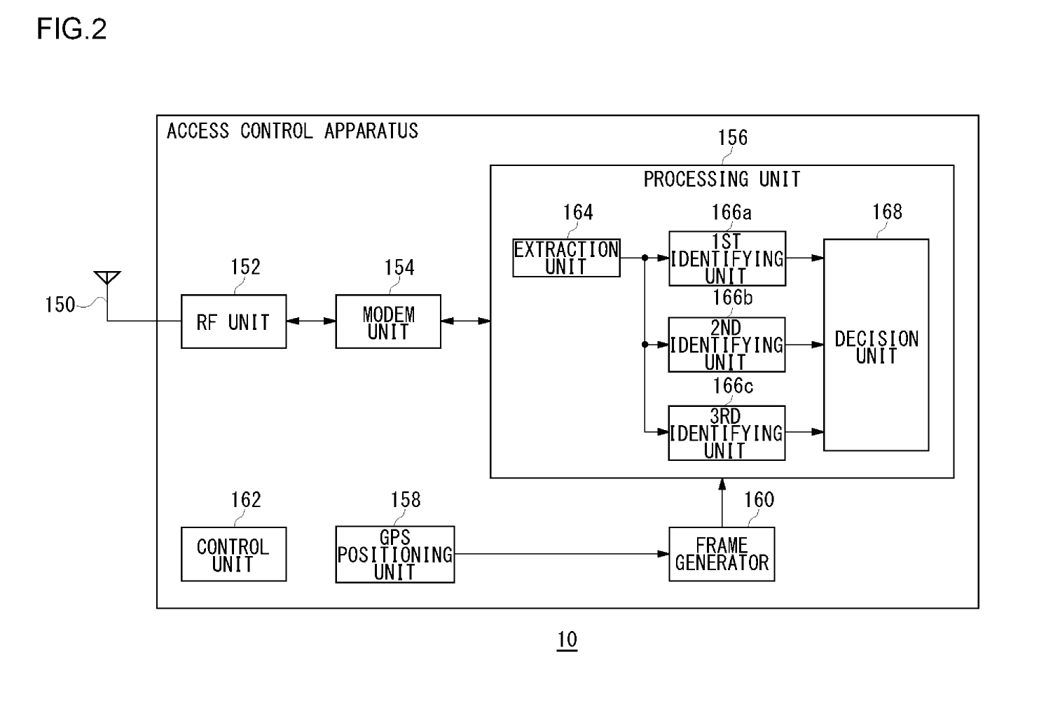

FIG. 2 shows a structure of the access control apparatus 10. The access control apparatus 10 includes an antenna 150, an RF unit 152, a modem unit 154, a processing unit 156, a GPS positioning unit 158, a frame generator 160, and a control unit 162. Also, the processing unit 156 includes an extraction unit 164, a first identifying unit 166a, a second identifying unit 166b and a third identifying unit 166c, which are generically referred to as “identifying unit 166” or “identifying units 166”, and a decision unit 168. The GPS positioning unit 158 receives signals from not-shown GPS satellites and acquires information on the time of day based on the received signals. It should be noted that known art can be used for the acquisition of information on the time of day and therefore the description thereof is omitted here. The GPS positioning unit 158 outputs the information on the time of day to the frame generator 160.

The frame generator 160 acquires information on the time of day from the GPS positioning unit 158. The frame generator 160 generates a plurality of frames based on the information on the time of day. For example, the frame generator 160 generates ten “100 msec” frames by dividing a duration of “1 sec” into 10 parts from the timing of “0 msec”. Frames are thus defined and specified repeatedly through the repetition of this process. Also, the frame generator 160 generates a plurality of slots by dividing each frame into a plurality of parts. For example, dividing a frame into 200 parts generates 200 slots with each slot being “500 μsec” long.

Here, one or more of a plurality of slots contained in each frame is/are reserved as “control slots”. For example, first five slots from the beginning of 200 slots contained in each frame are control slots. Also, the control slot is a slot used when the access control apparatus 10 broadcasts control information. The remaining slots of the plurality of slots in each frame are reserved and secured for the communications between not-shown terminal apparatuses. As previously indicated, since the communication system 100 employs the OFDM modulation scheme, each slot is so specified as to be composed of a plurality of OFDM symbols. Also, an OFDM symbol comprises a guard interval (GI) and a valid symbol. Note that a guard time may be provided in the front portion and the rear portion of each slot. It is to be noted also that a certain group of or combination of a plurality of OFDM symbols contained in a slot is equivalent to the packet signal mentioned earlier.

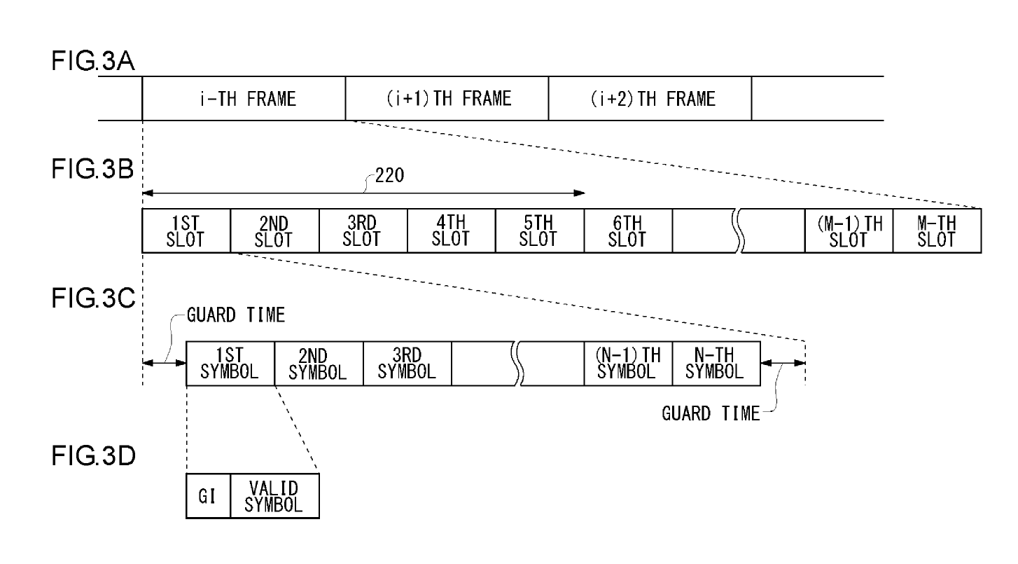

FIGS. 3A to 3D show the formats of frames generated by the frame generator 160. FIG. 3A shows a structure of frames. As shown in FIG. 3A, a plurality of frames, such as i-th frame to (i+2)th frame, are so specified as to be repeated. Also, the duration of each frame is “100 msec”, for instance. FIG. 3B shows a structure of a single frame. As shown in FIG. 3B, a single frame consists of M units of slots. For example, M is “200” and the duration of each slot is “500 μsec”. Also, slots assigned to the beginning part of each frame correspond to the control slots, and an interval where the control slots are assigned is indicated as a control region 220.

In this case, five slots which are a first slot to a fifth slot are contained in the control region 220 as the control slots. FIG. 3C shows a structure of a single slot. As shown in FIG. 3C, a guard time may be provided in the front portion and the rear portion of each slot. And the remaining duration of the slot consists of N units of OFDM symbols. FIG. 3D shows a structure of each OFDM symbol. As shown in FIG. 3D, each OFDM symbol consists of a GI and a valid symbol. Let us now refer back to FIG. 2.

The RF unit 152 receives through the antenna 150 a packet signal transmitted in communication between the other terminal apparatuses (not shown) in each slot, as a receiving processing. Here, if the frame containing a plurality of slots as in FIG. 3A is specified, the data is broadcast, using a slot selected from among the plurality of slots. That is, the RF unit 152 receives signals used in the communication between the terminal apparatuses wherein each of the signals are synchronous with the timing indicated by the control information. Also, data contains the identification number of a terminal apparatus which is a broadcast source. Accordingly, the RF unit 152 receives data from the terminal apparatus in each slot. The RF unit 152 performs a frequency conversion on the packet signal of a radiofrequency received through the antenna 150 and thereby generates a packet signal of baseband. Further, the RF unit 152 outputs the baseband packet signal to the modem unit 154. Generally, a baseband packet signal is formed of an in-phase component and a quadrature component, and therefore it should be represented by two signal lines. However, it is represented by a single signal line here to make the illustration clearer for understanding.

Also, the RF unit 152 includes an LNA (Low Noise Amplifier), a mixer, an AGC (Automatic Gain Control) unit, and an A-D conversion unit. As a transmission processing, the RF unit 152 performs a frequency conversion on the baseband packet signal inputted from the modem unit 154 and thereby generates a radiofrequency packet signal in each slot. Further, the RF unit 152 transmits, through the antenna 150, the radiofrequency packet signal. The RF unit 152 also includes a PA (Power Amplifier), a mixer, and a D-A conversion unit.

The modem unit 154 demodulates the baseband packet signal fed from the RF unit 152, as a receiving processing. Further, the modem unit 154 outputs the demodulation result to the processing unit 156. Also, the modem unit 154 modulates the data fed from the processing unit 156, as a transmission processing. Further, the modem unit 154 outputs the modulation result to the RF unit 152 as a baseband packet signal. It is to be noted here that the communication system 100 is compatible with the OFDM modulation scheme and therefore the modem unit 154 performs FFT (Fast Fourier Transform) as a receiving processing and performs IFFT (Inverse Fast Fourier Transform) as a transmission processing also.

The processing unit 156 receives information on the timing of a frame and the timings of slots contained in the frame, from the frame generator 160. The processing unit 156 identifies the timings of control slots contained in a plurality of slots contained in the frame. In the case of FIG. 3A, the five control slots contained in the control region 220 are identified. The processing unit 156 performs carrier sensing on each slot via the antenna 150, the RF unit 152 and the modem unit 154. Known art can be used as the carrier sensing and therefore the description thereof is omitted here. It is appreciated that the processing unit 156 may receive the received signals from the RF unit 152 without the signals being passed through the modem unit 154. The processing unit 156 selects one control slot out of the five control slots based on the carrier sensing result. For example, the control slot having the minimum interference power is selected.

The processing unit 156 generates control slot information on the selected control slot. Also, the processing unit 156 generates control information by adding the control slot information and the identification information thereto. The processing unit 156 assigns the control information to the selected control slot. The processing unit 156 outputs the control information to the modem unit 154, using the assigned control slot. Transmitting the control information using the control slot assigned by the communication system 100 is equivalent to notifying the timing of control slots in a frame. Since the relative position of control slots in a frame is contained in the control slot information, said transmitting the control information using the control slot assigned by the communication system 100 is also equivalent to notifying the timing of the frame. Here, the timing of frame corresponds to the timing to be synchronized when each terminal apparatus broadcasts data in the communications between the terminal apparatuses.

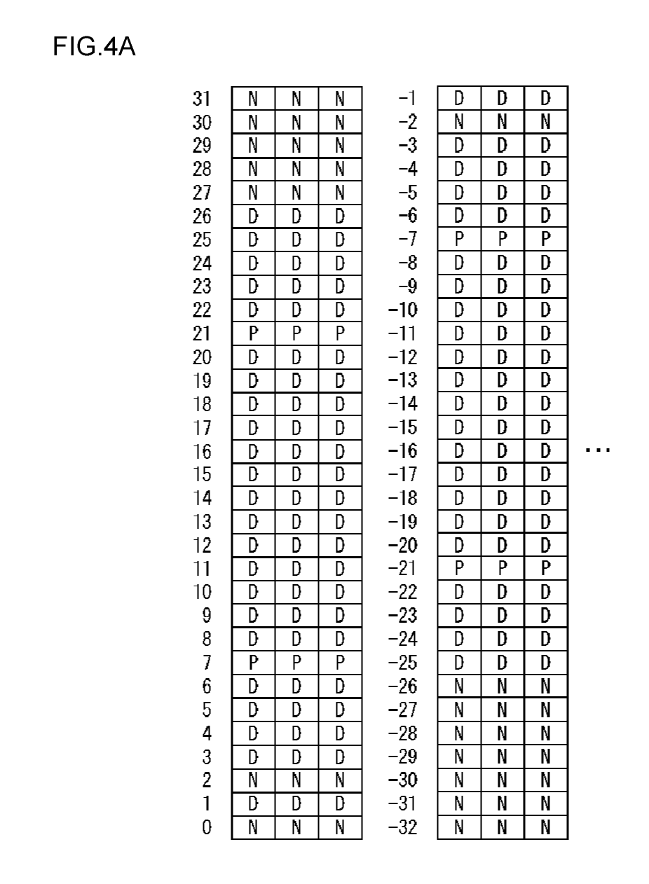

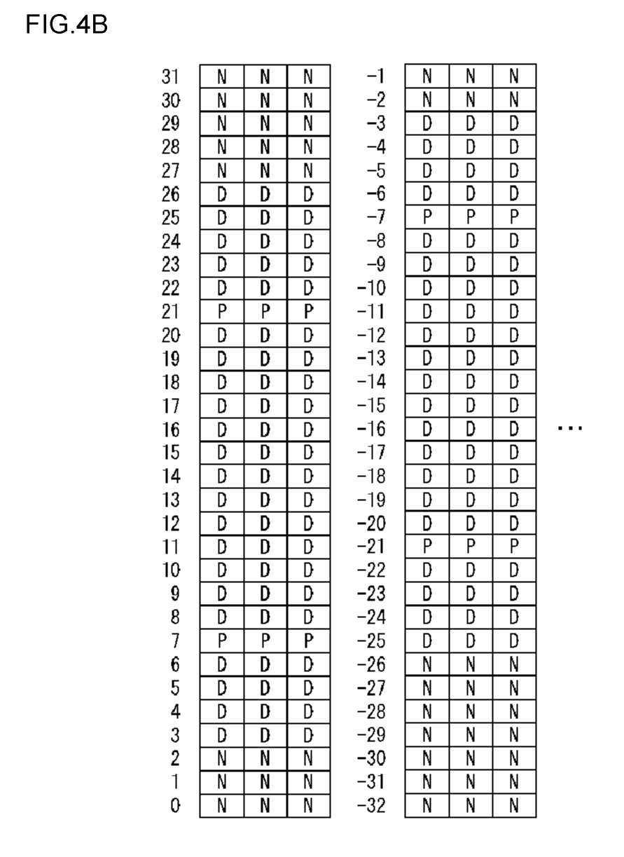

As described above, the communication system 100 is compatible with the OFDM modulation scheme and therefore the processing unit 156 generates the control information as an OFDM signal. Note here that the OFDM signals are also used for the communications between a not-shown plurality of terminal apparatuses. A description is given herein by comparing an OFDM signal that has the control information assigned (hereinafter this is sometimes called “control information” also) with an OFDM signal that has data assigned (hereinafter this is sometimes called “data” also). FIGS. 4A and 4B illustrate formats of OFDM symbols used in the communication system 100. FIG. 4A corresponds to control information, whereas FIG. 4B corresponds to data.

In both FIG. 4A and FIG. 4B, the vertical direction represents the frequency, whereas the horizontal direction represents time. The numbers “31”, “30”, . . . , “−32” are indicated from top along the vertical direction, and these are the numbers assigned to identify subcarriers (hereinafter referred to as “subcarrier numbers”). In OFDM signals, the frequency of a subcarrier whose subcarrier number is “31” is the highest, whereas the frequency of a subcarrier whose subcarrier number is “−32” is the lowest. In FIG. 4A and FIG. 4B, “D” corresponds to a data symbol, “P” a pilot symbol, and “N” a null.

What are common to the control information and the data are the subcarrier numbers “31” to “27”, “2”, “0”, and “−2”, and the subcarrier numbers “−26” to “−32” which are all null. In the control information, the subcarrier numbers “26” to “3”, “−3” to “−25” are also used in data, and the use of symbols is the same for both the control information and the data. In the control information, on the other hand, the subcarrier numbers “1” and “−1” are not used for data. These correspond to the aforementioned identification carriers. That is, the identification carrier is assigned to a subcarrier near the center frequency of an OFDM signal. In the control information, a guard band is provided between a subcarrier used also for data and the identification carrier, namely between the subcarrier number “2” and the subcarrier number “−2”. The subcarriers of the subcarrier number “−2” through the subcarrier number “2” may be collectively called “identification carrier” or “identification carriers”.

Here, the processing unit 156 assigns the information on frames and the slot numbers to the identification carrier. Also, the processing unit 156 may preferentially assign information having higher degrees of importance to the identification carrier. Also, a known signal is assigned to an OFDM symbol which is located anterior to the packet signal. Such a known signal is used for AGC (Automatic Gain Control) or used to estimate the channel characteristics. The processing unit 156 may assign a known signal to the identification carrier over a partial period of a predetermined slot. Such a known signal is used as a unique word (UW), for example. Let us now refer back to FIG. 2.

The modem unit 154 and the RF unit 152 transmit, by broadcast, the control information generated by the processing unit 156 from the antenna 150, using the control slots. One of the destinations of the control information is a terminal apparatus. The terminal apparatus having received the control information recognizes the timing of each slot and uses at least one of the remaining slots reserved for the communications between terminal apparatuses. If the terminal apparatus broadcasts the data over a plurality of frames, the terminal apparatus will use the same slots in corresponding timing in each frame.

When the extraction unit 164 detects that the signal received via the antenna 150, the RF unit 152 and the modem unit 154 is a signal which is not synchronous with the timing indicated by the control information (hereinafter referred to as “asynchronous signal”), the extraction unit 164 outputs the asynchronous signal to the identifying units 166. More specifically, if the received signal is fit into a slot, the extraction unit 164 will determine that the signal is synchronous with the timing of slot. If, on the other hand, the received signal is not fit into a slot, the extraction unit 164 will determine that the signal is an asynchronous signal. The extraction unit 164 stores signals which are to be checked, in memory. And if the signal is determined to be an asynchronous signal, the extraction unit 164 will output the asynchronous signal stored in memory to the identifying units 166.

The first identifying unit 166a receives the asynchronous signal fed from the extraction unit 164. The first identifying unit 166a identifies a continuous duration of asynchronous signal. More specifically, the first identifying unit 166a measures the received power of the asynchronous signal with predetermined timing. An average value of the received powers within a frequency domain of the OFDM symbols is preferably used as the received power. Also, the first identifying unit 166a continues to measure the received power. Further, the first identifying unit 166a compares the received power with a threshold value for power, and derives a period during which the received power continues to be larger than the threshold value for power. The first identifying unit 166a outputs the thus derived period to the decision unit 168 as the continuous duration of asynchronous signal.

The second identifying unit 166b receives the asynchronous signal fed from the extraction unit 164. Assume that the asynchronous signal received has been demodulated. The second identifying unit 166b derives the quality of the demodulated asynchronous signal. The quality herein means an error rate and EVM (Error Vector Magnitude), for instance. The second identifying unit 166b outputs the thus derived quality to the decision unit 168. The third identifying unit 166c receives the asynchronous signal fed from the extraction unit 164. The third identifying unit 166c identifies the degree of movement of an apparatus, which is the source of the asynchronous signal. More specifically, the third identifying unit 166c measures the received power of the asynchronous signal with predetermined timing, similarly to the first identifying unit 166a. The third identifying unit 166c continues to measure the received power for a predetermined period of time, and derives a variance value of the received powers in the predetermined period of time. The third identifying unit 166c outputs the variance value to the decision unit 168 as the degree of movement of an apparatus, which is the source of the asynchronous signal. The less the variance value is, the smaller the degree of movement thereof is.

The decision unit 168 receives the duration of asynchronous signal from the first identifying unit 166a, the quality thereof from the second identifying unit 166b, and the degree of movement from the third identifying unit 166c. If the continuous duration of asynchronous signal is longer than a threshold value for period and the quality thereof is more deteriorated than a threshold value for quality and additionally if the degree of movement is smaller than a threshold value for movement, then the decision unit 168 will determine that the asynchronous signal is a disturbing signal. When the disturbing signal is detected by the decision unit 168, the processing unit 156 adds the detection result indicating that the disturbing signal has been detected, to the control information. Also, the processing unit 56 adds information on the detected location of the disturbing signal, namely, information on the position where the access control apparatus 10 is installed, to the control information. As described above, the control information is transmitted, by broadcast, via the processing unit 156, the modem 154, the RF unit 152, and the antenna 150. The control unit 162 controls the processing of the access control apparatus 10 as a whole.

These structural components may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

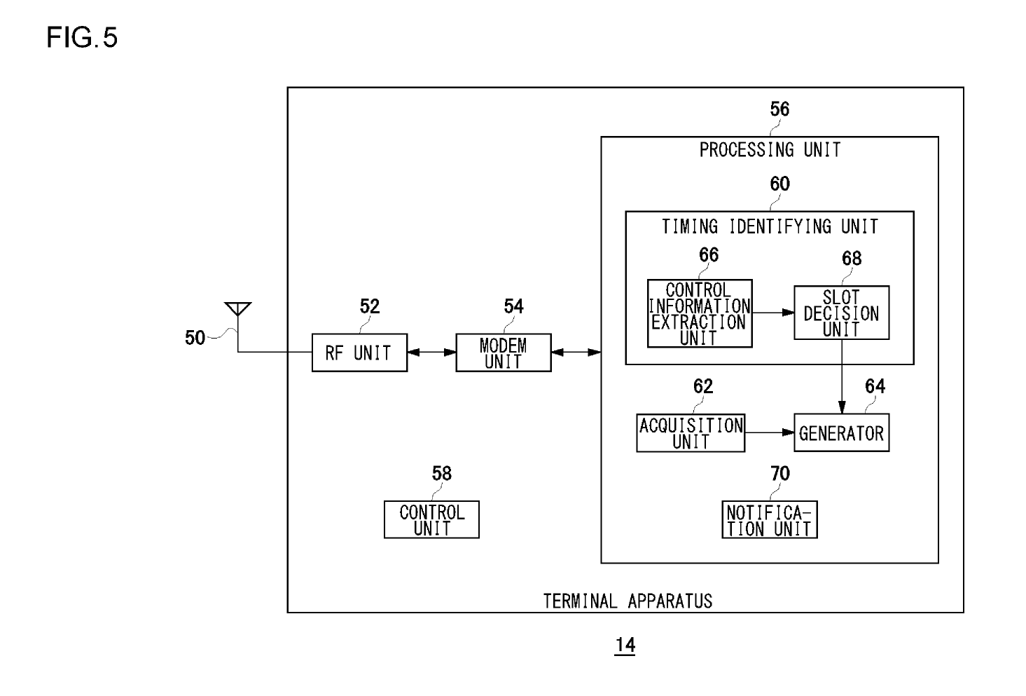

FIG. 5 shows a structure of a terminal apparatus 14 mounted on a vehicle 12. The terminal apparatus 14 includes an antenna 50, an RF unit 52, a modem unit 54, a processing unit 56, and a control unit 58. The processing unit 56 includes a timing identifying unit 60, an acquisition unit 62, a generator 64, and a notification unit 70. The timing identifying unit 60 includes a control information extraction unit 66 and a slot decision unit 68. The antenna 50, the RF unit 52 and the modem unit 54 carry out the processings similar to those carried out by the antenna 150, the RF unit 152 and the modem unit 154 of FIG. 2, respectively. Thus, the repeated description thereof is omitted here.

The acquisition unit 62 includes a GPS receiver, a gyroscope, a vehicle speed sensor, and so forth all of which are not shown in FIG. 5. The acquisition unit 62 acquires the present position, traveling direction, traveling speed and so forth of a not-shown vehicle 12, namely the vehicle 12 carrying the terminal apparatus 14, based on data supplied from the aforementioned not-shown components of the acquisition unit 62. The present position thereof is indicated by the latitude and longitude. Known art may be employed to acquire them and therefore the description thereof is omitted here. The acquisition unit 62 outputs the thus acquired information to the generator 64.

The control information extraction unit 66 receives the demodulation result fed from the modem unit 54. Of the demodulation result, the control information extraction unit 66 monitors a part of subcarriers corresponding to the identification carrier. If valid data is contained in the part of subcarriers corresponding to the identification carrier, the control information extraction unit 66 will recognize that the control information extraction unit 66 is receiving a slot containing the control information therein, namely a control slot. Also, the control information extraction unit 66 establishes the synchronization between frames and slots when the timing with which the slot containing the control information is received is used as a reference.

More specifically, the control information extraction unit 66 identifies the control slots where the received demodulation result is assigned, based on the control slot information contained in the control information. Then the control information extraction unit 66 generates frames with this identified control slot as a reference. If the control information corresponds to a third slot as shown in the FIG. 3B, the control information extraction unit 66 will generate frames with the third slot as a reference. In other words, the control information extraction unit 66 generates frames each containing a plurality of slots in such a manner as to synchronize with the frame corresponding to the control slot information. This corresponds to that the control information extraction unit 66 extracts, from the control information, information on the timing of a frame and the timings of slots contained in the frame. The control information extraction unit 66 outputs information on the thus generated frames to the slot decision unit 68.

The slot decision unit 68 measures, by carrier sensing, the interference power for each of a plurality of slots contained in the frame generated by the control information extraction unit 66. Also, the slot decision unit 68 estimates empty slots based on the interference powers. More specifically, the slot decision unit 68 stores a predetermined threshold value in advance, and compares the interference power at each slot against the threshold value. Also, the slot decision unit 68 estimates slots whose interference powers are below the threshold value, as empty slots, and randomly identifies one of the estimated empty slots. Note that the slot decision unit 68 may identify a slot whose interference power is the minimum. As a result, the slot decision unit 68 determines a slot which is synchronized with the control slot information and which arrives in cycles of frames.

The generator 64 generates data in such manner as to add the information, acquired by the acquisition unit 62, to the data. That is, the generator 64 generates data that contains the measured present position. The generator 64 transmits, by broadcast, the data via the modem unit 54, the RF unit 52, and antenna 50, using the slot identified by the slot decision unit 68.

The notification unit 70 acquires the data sent from not-shown other terminal apparatuses 14 and conveys the approach or the like of the not-shown other vehicles 12 to the driver via a monitor or speaker according to the content of the data, in each slot. The processing performed by the notification unit 70 is not limited thereto. The processing unit 56 extracts, from the control signal, information on a slot being used by a malfunctioning terminal, identifies the slot based on the thus extracted information, and skips the receiving processing in this slot. Now, if a detection result indicating that a disturbing signal has been detected is contained in the control information, the processing unit 56 will extract it and also extract the information on a detected location. Also, the processing unit 56 outputs the information on a detected location to the notification unit 70. Upon receipt of the information on a detected location, the notification unit 70 displays characters like “there is a disturbing signal near here” to draw attention. Through this display, the driver expects to have a chance of not being notified from the notification unit 70 of an approaching vehicle 12. The control unit 58 controls the entire operation of the terminal apparatus 14.

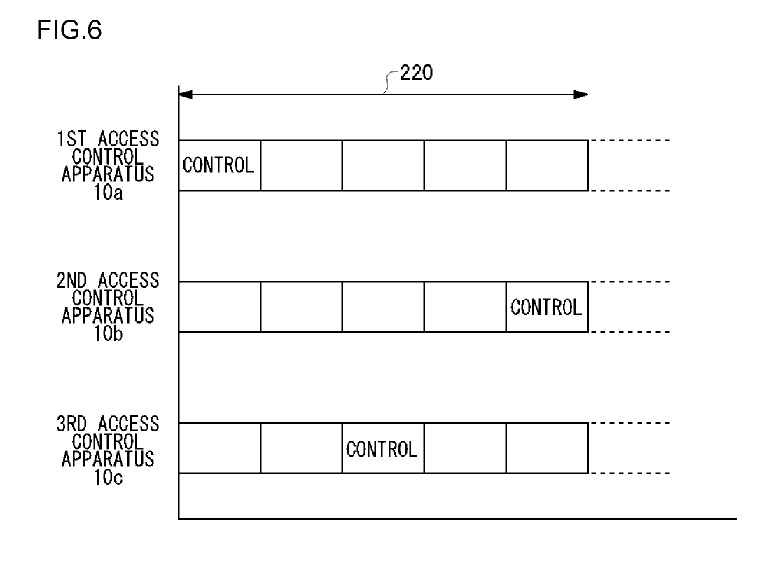

An operation of the communication system 100 configured as above is now described. FIG. 6 shows an operational overview of the communication system 100. The horizontal direction of FIG. 6 corresponds to time, and the first access control apparatus 10a to the third access control apparatus 10c are indicated along the vertical direction of FIG. 6. Only the control region 220 in FIG. 3B is shown in FIG. 6. As described earlier, assumed herein that five control slots are assigned to the control region 220. “Control” in FIG. 6 indicates control information. The first access control apparatus 10a uses the leading control slot. The second access control apparatus 10b uses the fifth control slot. The third access control apparatus 10c uses the third control slot. As a result, the interference among the control information transmitted by broadcast from the respective access control apparatuses 10 is reduced.

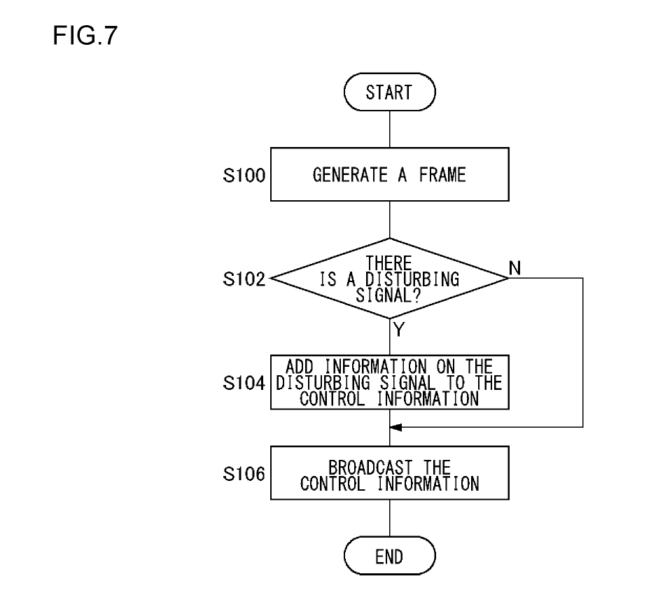

FIG. 7 is a flowchart showing a procedure in which control information is broadcast by the access control apparatus 10. The frame generator 160 generates frames (S100). If the decision unit 168 detects the presence of a disturbing signal (Y of S102), the processing unit 156 will add information on the disturbing signal to the control information (S104). If the decision unit 168 does not estimate the presence of a disturbing signal (N of S102), Step S104 will be skipped. The processing unit 156, the modem unit 154, the RF unit 152 and the antenna 150 broadcast the control information (S106).

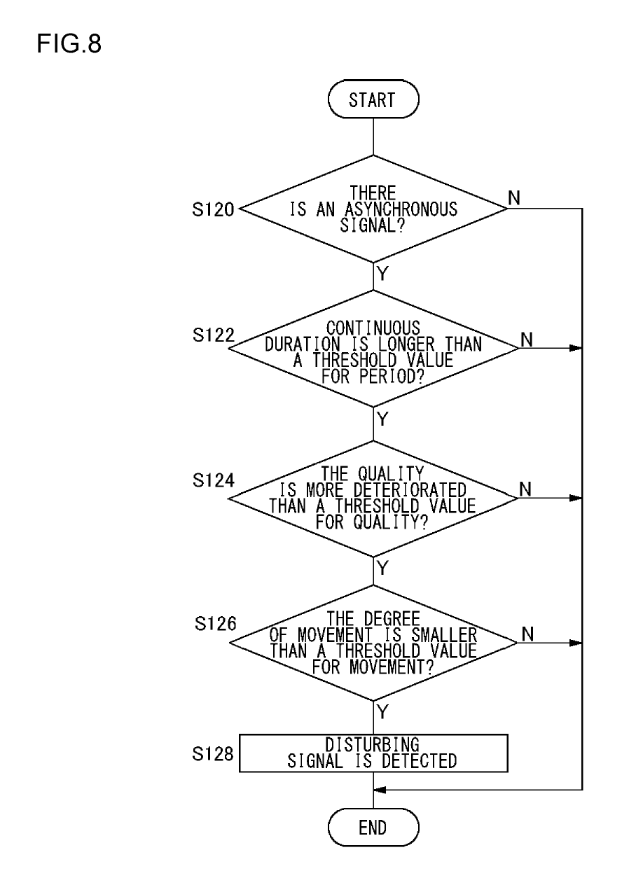

FIG. 8 is a flowchart showing a procedure in which a disturbing signal is detected by the access control apparatus of FIG. 7. This corresponds to the processing of Step S102 in FIG. 7. If (1) the extraction unit 164 detects an asynchronous signal (Y of S120), (2) the continuous duration identified by the first identifying unit 166a is longer than a threshold value for period (Y of S122), (3) the quality identified by the second identifying unit 166b is more deteriorated than a threshold value for quality (Y of S124), and (4) the degree of movement identified by the third identifying unit 166c is smaller than a threshold value for movement (Y of S126), the decision unit 168 will determine the detection of a disturbing signal (S128). If, on the other hand, (1) the extraction unit 164 does not detect an asynchronous signal (N of S120), (2) the continuous duration identified by the first identifying unit 166a is not longer than the threshold value for period (N of S122), (3) the quality identified by the second identifying unit 166b is not more deteriorated than the threshold value for quality (N of S124), or (4) the degree of movement identified by the third identifying unit 166c is not smaller than the threshold value for movement (N of S126), the processing will be terminated.

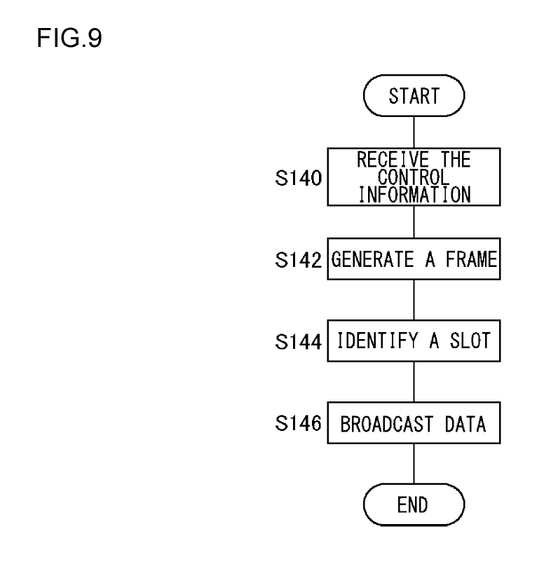

FIG. 9 is a flowchart showing a procedure in which data is broadcast by the terminal apparatus 14. The control information extraction unit 66 receives the control information (S140) and generates frames (S142) before the slot decision unit 68 identifies slots (S144). The processing unit 56, the modem unit 54, the RF unit 52, and the antenna 50 broadcast the data (S146).

A modification will now be described. Similar to the exemplary embodiments, the modification relates to a communication system 100 including the access control apparatus 10 and the terminal apparatuses 14. In the exemplary embodiments, the access control apparatus 10 broadcasts the timing of a frame and the detection result of a malfunctioning terminal apparatus, using the control information. According to the modification, on the other hand, the access control apparatus 10 broadcasts frames by adding still another information to the control information for the purpose of further reducing the collision probability of data. The access control apparatus 10 identifies slots not used in communication among a plurality of terminal terminals (hereinafter referred to as “empty slots” or “unused slots”) by measuring the received power in each slot. Note that those which may be assigned as the empty slots are those excluding the control slots. The access control apparatus 10 identifies slots having any collision (hereinafter referred to as “collision slots”) by also measuring in each slot for any collision of packet signals transmitted by the plurality of terminal apparatuses. Note also that those which may be identified as the collision slots are those excluding the control slots.

The access control apparatus 10 also adds information on the identified empty slots and collision slots to the control information. The terminal apparatus 14 estimates empty slots based on the control information, and randomly selects a slot out of the empty slots. Further, the terminal apparatus 14 transmits, by broadcast, the data using the selected slot. The communication system 100 according to the modification is of similar type to those described in conjunction with FIG. 1 and FIG. 5. A description is given here centering around features different from those described in conjunction with FIG. 1 and FIG. 5.

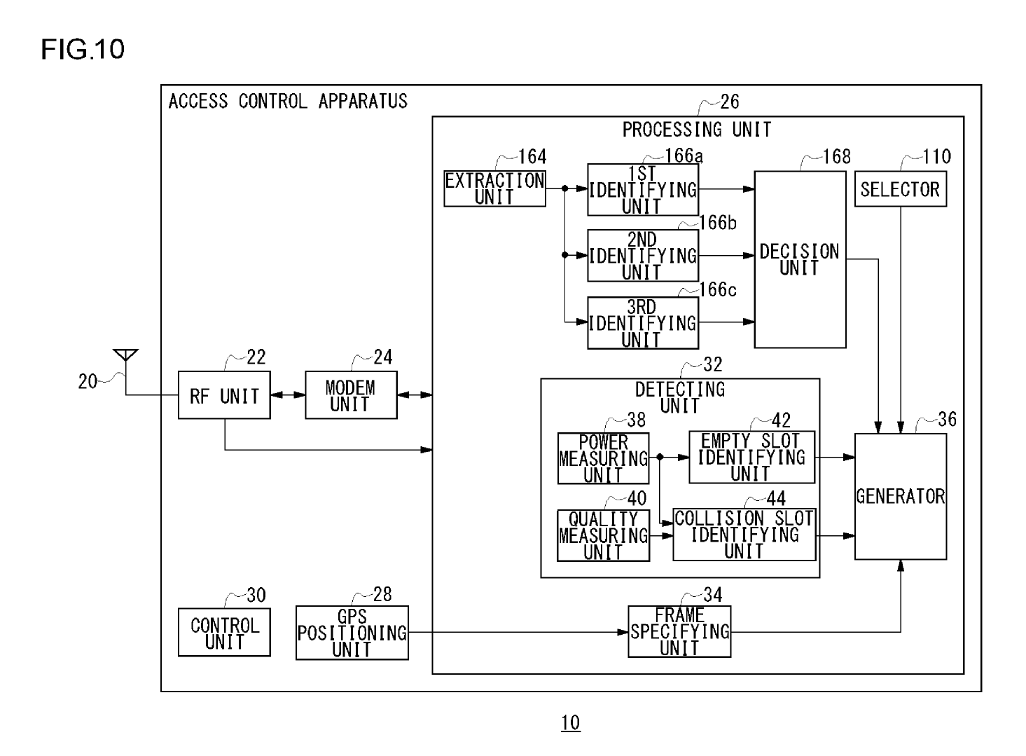

FIG. 10 shows a structure of the access control apparatus 10 according to a modification. The access control apparatus 10 includes an antenna 20, an RF unit 22, a modem unit 24, a processing unit 26, a GPS positioning unit 28, and a control unit 30. The processing unit 26 includes a detecting unit 32, a frame specifying unit 34, a generator 36, and a selector 110, an extraction unit 164, a first identifying unit 166a, a second identifying unit 166b and a third identifying unit 166c, which are generically referred to as “identifying unit 166” or “identifying units 166”, and a decision unit 168. The detecting unit 32 includes a power measuring unit 38, a quality measuring unit 40, an empty slot identifying unit 42, and a collision slot identifying unit 44. The antenna 20, the RF unit 22, the modem unit 24, the GPS positioning unit 28, the control unit 30, the frame specifying unit 34, the extraction unit 164, the identifying unit 166, and the decision unit 168 correspond respectively to the antenna 150, the RF unit 152, the modem unit 154, the GPS positioning unit 158, the control unit 162, the frame generator 160, the extraction unit 164, the identifying unit 166, and the decision unit 168, and therefore the repeated description thereof is omitted here. In particular, a description of the detection and broadcasting of a disturbing signal are omitted here.

The selector 110 performs carrier sensing on each slot of the respective plurality of control slots in the control region 220, and selects one control slot out of them based on the carrier sensing result. Since the processing performed by the selector 110 is similar to that performed by the processing unit 156 of FIG. 2, the description thereof is omitted here. The selector 110 outputs information on the selected control slot to the generator 36.

The power measuring unit 38 receives a received signal from the RF unit 22 or the modem unit 24 and measures the received power. Note that the received power is measured slot by slot. Also, slots correspond to slots other than the control slots. Hence, the power measuring unit 38 measures the received power for each of the plurality of slots. The power measuring unit 38 outputs the received power for each slot to the empty slot identifying unit 42 and the collision slot identifying unit 44. The quality measuring unit 40 receives the demodulation result from the modem unit 24 and measures the signal quality for each of the plurality of slots. The signal quality measured herein is the error rate. Here, slots correspond to slots other than the control slots, too. It should be noted that known art can be used for the measurement of the error rate, so that the description thereof is omitted here. Also, instead of the error rate, EVM (Error Vector Magnitude) or the like may be measured as the signal quality. The quality measuring unit 40 outputs the error rate to the collision slot identifying unit 44.

The empty slot identifying unit 42 receives the received power for each slot from the power measuring unit 38. The empty slot identifying unit 42 compares each received power against a threshold value (hereinafter referred to as “threshold value for empty slot”) and identifies the slot for which the received power is smaller than the threshold value for empty slot. That is, the empty slot identifying unit 42 detects, from among a plurality of slots other than those contained in the control region 220, a slot that can be used in communication among a plurality of terminal apparatuses, as an empty slot. Note here that when there are a plurality of empty slots, the empty slot identifying unit 42 identifies them as empty slots. The empty slot identifying unit 42 outputs information on the identified empty slots to the generator 36.

The collision slot identifying unit 44 receives the received power for each slot from the power measuring unit 38 and receives the error rate for each slot from the quality measuring unit 40. Also, the collision slot identifying unit 44 associates the received power with the error rate, slot by slot. The collision slot identifying unit 44 not only compares the received power against a first threshold value, but also compares the error rate against a second threshold value, slot by slot. The collision slot identifying unit 44 identifies, as a collision slot, a slot for which the received power is larger than the first threshold value and at the same time the error rate is higher than the second threshold value. That is, the collision slot identifying unit 44 recognizes, as a collision slot, a slot for which the received power is large but the communication quality is inferior. In this manner, the collision slot identifying unit 44 detects, as a collision slot, a slot in which a collision has occurred due to duplicate transmission of signals sent from a plurality of terminal apparatuses. The collision slot identifying unit 44 outputs information on the identified collision slots to the generator 36.

The generator 36 receives information on empty slots from the empty slot identifying unit 42 and also receives information on collision slots from the collision slot identifying unit 44. The generator 36 generates control information by adding the information on empty slots and the information on collision slots thereto. Note here that the numbers, 1, 2, . . . from the start (hereinafter referred to as “slot numbers”) are given respectively to a plurality of slots contained in a frame. The generator 36 adds the slot number(s) of the empty slot(s) contained in the previous frame(s) as information on empty slots to the control information. Further, as the generator 36 receives (1) a detection result that the a disturbing signal has been detected by the decision unit 168 and (2) information on a detected location, the generator 36 stores these pieces of information in the control information, too. Also, the generator 36 receives information on frames and slots from the frame specifying unit 34. The generator 36 periodically assigns the control information to any one of control slots. The generator 36 outputs the control information to the modem unit 24, using the thus assigned control slot.

In the exemplary embodiments, the slot decision unit 68 of the terminal apparatus 14 estimates empty slots based on the carrier sensing result. According to the modification, in contrast thereto, the slot decision unit 68 estimates empty slots based on the information on empty slots and/or the information on collision slots contained in the control information. A description is given herein of processing performed by the terminal apparatus 14 according to the modification.

The control information extraction unit 66 receives the control information fed from the modem unit 54. The control information extraction unit 66 acquires the information on empty slots and the information on collision slots from the control information. The control information extraction unit 66 outputs the information on empty slots and the information on collision slots to the slot decision unit 68. The slot decision unit 68 receives the information on empty slots and the information on collision slots from the control information extraction unit 66. The slot decision unit 68 selects empty slot(s) from among the slots excluding those of the control region 220 in each frame.

While such processing continues, the control information extraction unit 66 continues to extract the information on empty slots and the information on collision slots, from the control information, frame by frame. Based on the information on collision slots, the slot decision unit 68 checks to see if any of the slot numbers corresponding to the slots in current use is mistaken as a collision slot. If no slot is mistaken as a collision slot, the slot decision unit 68 will continue to output the same slot numbers as before to the generator 64. If, on the other hand, any slot is mistaken as a collision slot, the slot decision unit 68 will again estimate empty slots based on the information on empty slots. In other words, the slot decision unit 68 repeats the previous processing.

If the control information received by the control information extraction unit 66 does not contain the information on empty slots, the slot decision unit 68 may execute the operation described in the exemplary embodiments. This corresponds to a case where broadcast is not the control information from the access control apparatus 10 of FIG. 10 but the control information from the access control apparatus 10 of FIG. 2. In this case, the slot decision unit 68 performs carrier sensing on each of a plurality of slots contained in the frame generated by the control information extraction unit 66. If the control information extraction unit 66 does not receive the information on empty slots, the slot decision unit 68 will estimate empty slots based on the carrier sensing execution result.

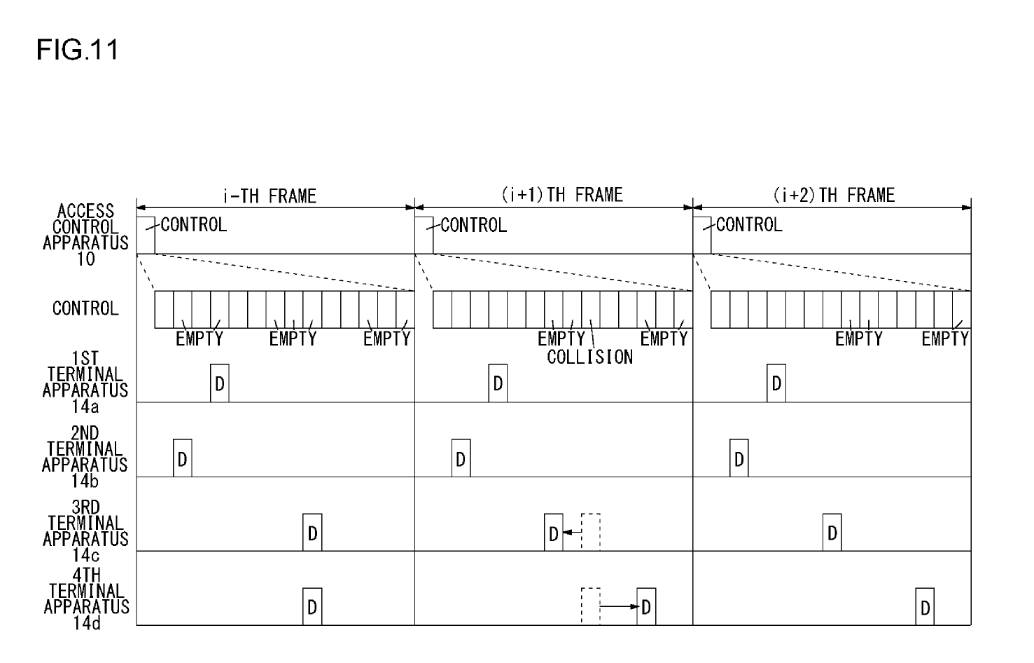

FIG. 11 shows an operational overview of the communication system 100 according to the modification. The horizontal direction of FIG. 11 corresponds to time, and three frames that are an ith frame to an (i+2)th frame are indicated as described in the top row. Assume herein for the clarity of description that the number of control slots contained in each frame is one and each frame contains 15 slots. As shown in FIG. 11, the access control apparatus 10 broadcasts the control information using the leading slot of each frame. “Control” in FIG. 11 indicates control information. Below “control”, information on empty slots and information on collision slots both contained in the control information are indicated by associating them with slots. “Empty” in FIG. 11 indicates an empty slot, whereas “collision” in FIG. 11 indicates a collision slot.

In the rows below the top row, the timings with which the first terminal apparatus 14a to the fourth terminal apparatus 14d broadcast the data are indicated. “D” in FIG. 11 means data. The first terminal apparatus 14a to the fourth terminal apparatus 14d each references the control information and selects an empty slot. The first terminal apparatus 14a to fourth terminal apparatus 14d each broadcasts the data using the selected empty slot in the ith frame. Since the empty slot selected by the third terminal apparatus 14c is identical to the empty slot selected by the fourth terminal apparatus 14d, the data broadcast from them collide with each other. The access control apparatus 10 detects the occurrence of collision in said slot. The control information, broadcast from the access control apparatus 10, in the (i+1)th frame indicates the slot where the collision occurs, as the information on the collision slot.

Since no collision occurs in the slots used by the first terminal apparatus 14a and the second terminal apparatus 14b, the slots having the same slot numbers are used again. On the other hand, since collision has occurred in the slots used by the third terminal apparatus 14c and the fourth terminal apparatus 14d, different empty slots are selected again. The third terminal apparatus 14c and the fourth terminal apparatus 14d broadcast the data, using the selected empty slots. Since not all of data collides, the collision slots are not indicated in the control information, broadcast from the access control apparatus 10, in the (i+2)th frame. Thus, the first terminal apparatus 14a to the fourth terminal apparatus 14d use again the slots, having the same slot numbers as the slots used already, in the (i+2)th frame.

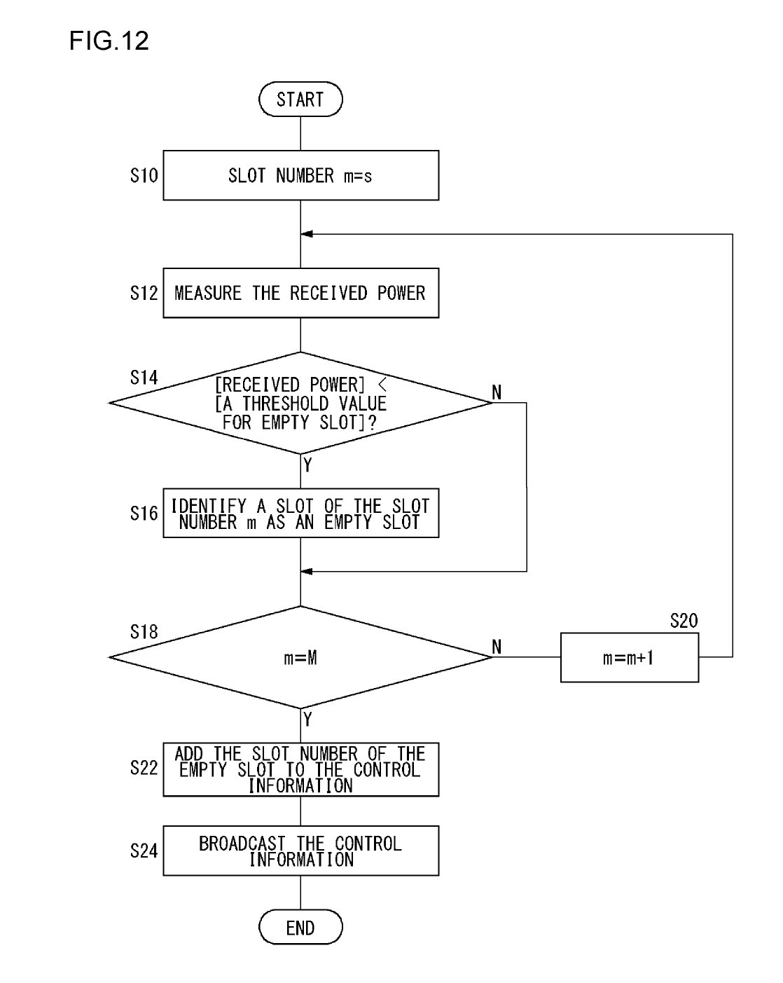

FIG. 12 is a flowchart showing a procedure in which the access control apparatus 10 conveys an empty slot. The detecting unit 32 sets the slot number m to “s” (S10). The power measuring unit 38 measures the received power (S12). If the received power is less than the threshold value for empty slot (Y of S14), the empty slot identifying unit 42 will identify the slot of the slot number m as an empty slot (S16). If the received power is not less than the threshold value for empty slot (N of S14), the empty slot identifying unit 42 will skip the process of Step S16. If the slot number m is not equal to the maximum number M (N of S18), the detecting unit 32 will increment the slot number m by 1 (S20) and the process will return to Step S12. If, on the other hand, the slot number m is the maximum number M (Y of S18), the generator 36 will add the slot number of the empty slot to the control information (S22). The modem unit 24 and the RF unit 22 broadcast the control information (S24).

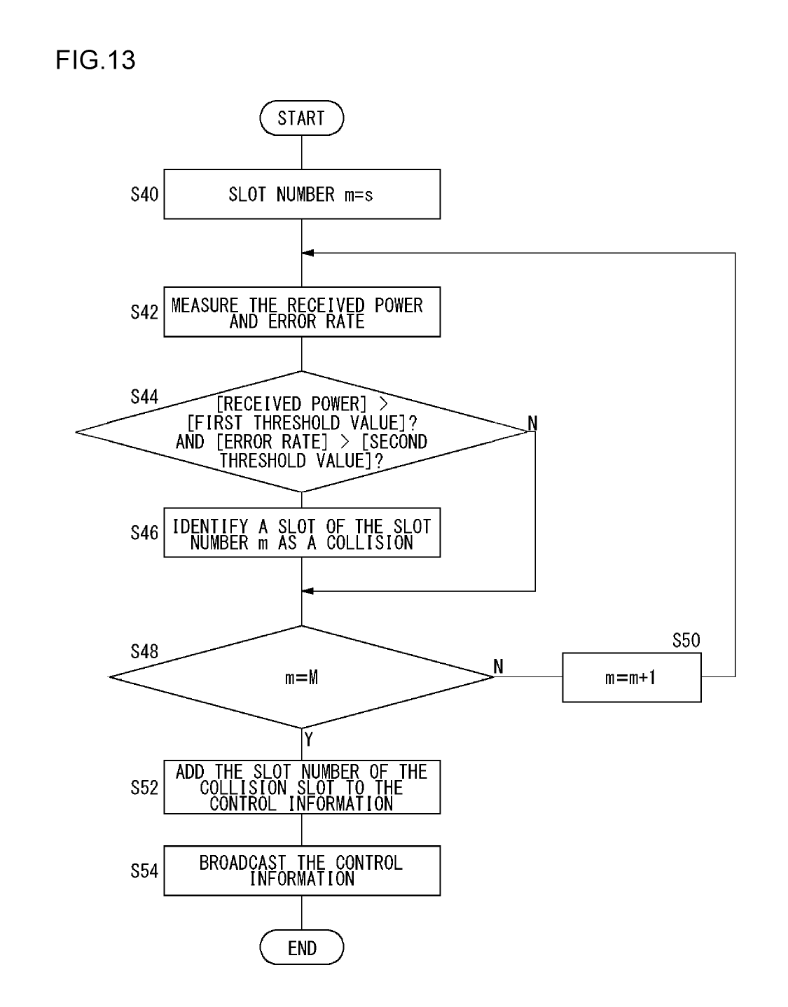

FIG. 13 is a flowchart showing a procedure in which the access control apparatus 10 conveys a collision slot. The detecting unit 32 sets the slot number m to “s” (S40). The power measuring unit 38 measures the received power, and the quality measuring unit 40 measures the error rate (S42). If the received power is greater than the first threshold value and the error rate is greater than the second threshold value (Y of S44), the collision slot identifying unit 44 will identify the slot of the slot number m as a collision slot (S46). If the received power is not greater than the first threshold value or the error rate is not greater than the second threshold value (N of S44), the collision slot identifying unit 44 will skip the process of Step S46. If the slot number m is not equal to the maximum number M (N of S48), the detecting unit 32 will increment the slot number m by 1 (S50) and the process will return to Step S42. If, on the other hand, the slot number m is the maximum number M (Y of S48), the generator 36 will add the slot number of the collision slot to the control information (S52). The modem unit 24 and the RF unit 22 broadcast the control information (S54).

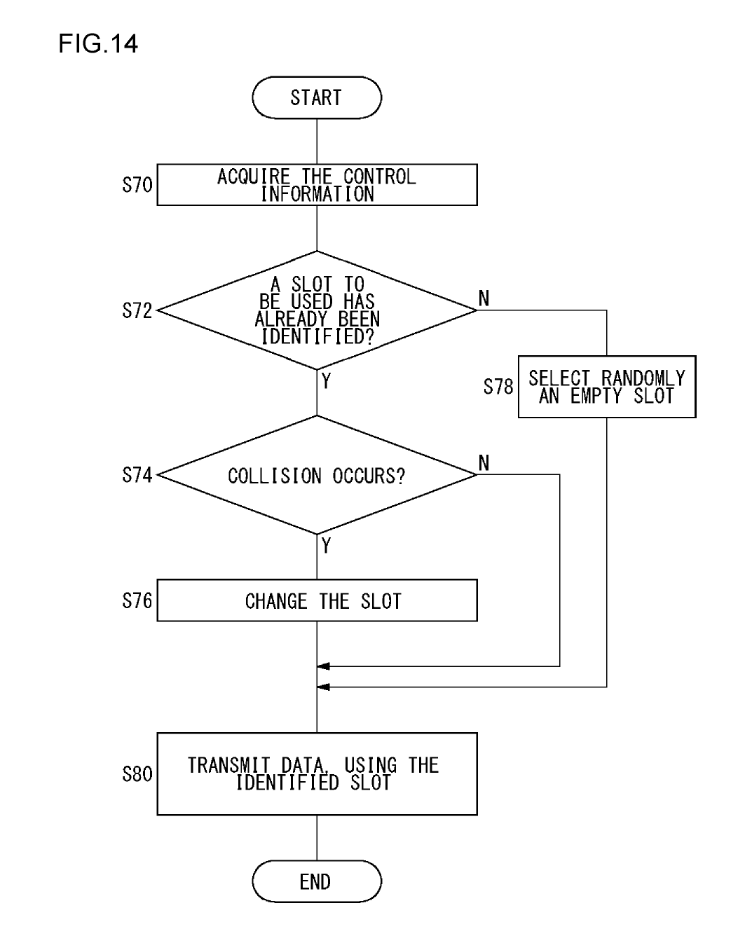

FIG. 14 is a flowchart showing a data transmission procedure performed by the terminal apparatus 14 according to the modification. The control information extraction unit 66 acquires the control information (S70). If a slot to be used has already been identified (Y of S72), the slot decision unit 68 will verify whether collision occurs in this slot or not. If collision occurs (Y of S74), the slot decision unit 68 will change the slot (S76). If no collision occurs (N of S74), Step S76 will be skipped. If, on the other hand, a slot to be used has not already been identified (N of S72), the slot decision unit 68 will estimate empty slots and then randomly identify an empty slot (S78). The generator 64 transmits the data, using the thus identified slot (S80).

Another modification will now be described. When a wireless LAN is applied to the inter-vehicular communication, a need arises to transmit information to a large indefinite number of terminal apparatuses, and therefore it is desirable that signals be sent by broadcast. Yet, at an intersection or like places, an increase in the number of vehicles, that is, an increased number of terminal apparatuses and an increased traffic volume thereby, is considered to cause an increase in the collisions of the packet signals therefrom. In consequence, data contained in the packet signals may not be transmitted to the other terminal apparatuses. If such a condition occurs in the inter-vehicular communication, then the objective of preventing collision accidents of vehicles on a sudden encounter at an intersection will not be attained. Such a condition where the packet signals are less likely to be received may also occur when disturbing signals are present besides the increased traffic volume. If one is aware of such an area where the disturbing signals are present before entering the area, processing appropriate for such a situation can be carried out. An object of the another modification is to provide the technology capable of knowing the existent position of such an area where the radio wave circumstances degrade.

The another modification of an embodiment relates to a communication system carrying out data communication between terminal apparatuses installed in vehicles. A terminal apparatus transmits, by broadcast, packet signals containing information such as the traveling speed and position of a vehicle (hereinafter referred to as “data”). And the other terminal apparatuses receive the packet signals and recognize the approach or the like of the vehicle based on the data. Note here that the terminal apparatuses employ the OFDM modulation scheme to achieve faster communication speed. Under these circumstances, an increase in the number of terminal apparatuses at an intersection or like place increases the probability of packet signals occurring. To cope with it, the communication system according to the another modification executes the following processes.

The communication system according to the another modification includes an access control apparatus in addition to a plurality of terminal apparatuses, and the access control apparatus is installed at an intersection, for instance. The access control apparatus repeatedly specifies a frame containing a plurality of slots. Note that one or more of the plurality of slots contained in each frame are reserved and secured as control slots. Also, the access control apparatus identifies control slots to be used, and adds information on timings of the control slots and information with which to identify said access apparatus (hereinafter referred to as “identification information) to the control information. Also, the access control apparatus transmits, by broadcast, a packet signal containing the control information (hereinafter referred to sometimes as “control information” also) using the control slots. Here, the information on timings of the control slots is, for instance, information on which slot number, starting from the beginning of a frame, the control slot is assigned to (this information will be referred to as “control slot information”).

A terminal apparatus receives the control information and thereby generates a frame corresponding to the control information. The thus generated frame contains a plurality of slots as well. Also, the terminal apparatus recognizes slots, in the plurality of slots contained in the frame, which are other than the control slots. Note that in the description of terminal apparatuses given hereunder the slots sometimes mean those excluding the control slots. Each terminal apparatus performs carrier sensing on a plurality of slots, respectively, and thereby it estimates a slot which is not used by other terminal terminals (hereinafter referred to as “empty slot” or “unused slot”). There may be a plurality of such empty slots. The terminal apparatus selects at random one slot to be used for the transmission of data from among empty slots. The terminal apparatus transmits, by broadcast, a packet signal containing data (hereinafter referred to sometimes as “data” also) using the selected slot. The terminal apparatus uses a relatively identical slot for a plurality of frames.

Note here that the access control apparatus has no direct involvement in data communication between terminal apparatuses, that is, the access control apparatus does not directly specify the slot to be used in the data communication. In other words, the access control apparatus only conveys the construction of a frame containing slots to be used by a plurality of terminal apparatus. The terminal apparatus performs data communication with timings of slots contained in the frame notified by the access control apparatus. That is, the access control apparatus controls the communications between a plurality of terminal apparatuses.

It is to be noted that since the control information is also transmitted in a single slot, there are chances that the data transmitted from a terminal apparatus incapable of receiving the control information may collide with the control information. In consequence, if the other terminal apparatuses cannot receive the control information, then there arises a difficulty of carrying out the aforementioned processes. To cope with this situation, the OFDM signals used in transmitting data have some of the subcarriers as null carriers in which no data is contained (these subcarriers being hereinafter referred to as “identification carriers”). On the other hand, the OFDM signals used in transmitting control information have signals placed in the identification carriers, too. Hence, even when there is a collision between data and control information, the terminal apparatus can detect the presence of control information by observing the signal components of the identification carrier.

Further, if a plurality of access apparatuses are installed at an intersection where they are located close to each other, interference between them must be taken into consideration. If, for instance, the control information transmitted by broadcast from the plurality of access control apparatuses interfere with each other, the terminal apparatuses may not be able to receive the control information and therefore the aforementioned operations will not be achieved. Though such interference can be avoided by assigning a different frequency channel to each access control apparatus, another separate structure to reduce the interference will be needed if no other frequency channel can be provided. To cope with this, a plurality of control slots are reserved and secured as described above. Each access control apparatus performs carrier sensing on a plurality of control slots, respectively, and thereby it selects one control slot and transmits, by broadcast, the control information using the selected control slot.

Even in such a case as defined above, it is possible that the radio wave environment surrounding the terminal apparatus deteriorates. The degradation in the radio wave environment is caused by an increased traffic volume and the presence of disturbing signals. Since the access control apparatus is installed in a position different from the terminal apparatus, the access control apparatus cannot recognize the degradation in the radio environment surrounding the terminal apparatus. Further, if there is an area which is not covered by the access control apparatus, such degradation in the radio wave environment will not be recognized by the access control apparatus because terminal apparatuses only are operating in such an uncovered area. Under this condition, if a terminal apparatus can recognize that the radio wave environment is deteriorating, before entering the area, it is possible that such a fact is conveyed to the driver and the amount of data to be sent is suppressed. In the former case, the driver can predict the approach of vehicle(s) without being notified of the approach of vehicles, whereas in the latter case the collision probability of data can be reduced. Hence, the following processes are carried out to have the terminal apparatus recognize that the radio wave environment is deteriorated.

The terminal apparatus measures the radio wave environment. If the radio wave environment measured is deteriorated, the terminal apparatus will store a combination of a detection result indicating that the radio wave environment is deteriorated and the information on a detected location (hereinafter this combination of information will be referred to as “degradation information”). After a predetermined period of time has elapsed after the degradation information has been stored, the terminal apparatus transmits, by broadcast, data containing the degradation information. In this case, if the terminal apparatus does not receive the control information sent from the access control information, that is, if the terminal apparatus is not in an area formed by the access control apparatus, the terminal apparatus may stop transmitting the degradation information until it enters the area. Upon receipt of the degradation information, the access control apparatus adds at least part of the degradation information to the control information and transmits, by broadcast, the control information containing at least part of the degradation information. Other terminal apparatuses, which have received the degradation information, recognize the position where the radio wave environment has deteriorated.

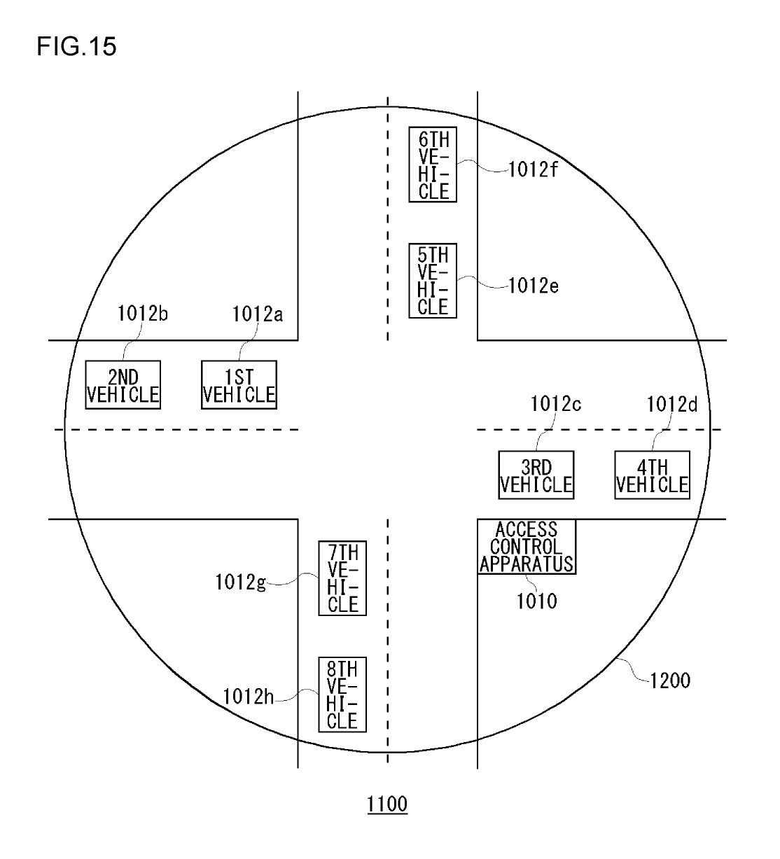

FIG. 15 shows a structure of a communication system 1100 according to the another modification. FIG. 15 corresponds to a case thereof at an intersection viewed from above. The communication system 1100 includes an access control apparatus 1010 and a first vehicle 1012a, a second vehicle 1012b, a third vehicle 1012c, a fourth vehicle 1012d, a fifth vehicle 1012e, a sixth vehicle 1012f, a seventh vehicle 1012g, and an eighth vehicle 1012h, which are generically referred to as “vehicle 1012” or “vehicles 1012”. It is to be noted that each vehicle 1012 has a not-shown terminal apparatus installed therein. Also, an area 1200 is formed by the access control apparatus 1010.

As shown in FIG. 15, a road extending in the horizontal, or left-right, direction and a road extending in the vertical, or up-down, direction in FIG. 1 intersect with each other in the central portion thereof. Note here that the upper side of FIG. 15 corresponds to the north, the left side thereof the west, the down side thereof the south, and the right side thereof the east. And the portion where the two roads intersect each other is the intersection. The first vehicle 1012a and the second vehicle 1012b are advancing from left to right, while the third vehicle 1012c and the fourth vehicle 1012d are advancing from right to left. Also, the fifth vehicle 1012e and the sixth vehicle 1012f are advancing downward, while the seventh vehicle 1012g and the eighth vehicle 1012h are advancing upward.

The terminal apparatus installed in each of the vehicles 1012 acquires data and transmits, by broadcast, a packet signal containing the data. Here, before explaining another modification, a description will be given of an operation of a terminal apparatus which is compatible with a known wireless LAN, i.e., CSMA/CA. Each terminal apparatus transmits data by broadcast when it has determined by executing carrier sense that transmission is possible. Consequently, there are chances of data from a plurality of terminal apparatuses colliding with each other. Also, as the number of terminal apparatuses increases, there will be greater probability of collisions occurring. In particular, at locations like intersections, the likelihood of data collision is greater despite the fact that the likelihood of vehicles 1012 colliding with each other is also great. This means failed utilization of data in spots where data is in the greatest demand.

Therefore, the communication system 100 places an access control apparatus 1010 at each intersection. The access control apparatus 10 repeatedly generates a frame containing a plurality of slots, based on the signals received from not-shown GPS satellites. Here, one or more of the plurality of slots correspond to the control slots. The access control apparatus 1010 adds the control slot information and the identification information to the control information. Further, the access control apparatus 1010 broadcasts the control information, using control slots. The selection of the control slot(s) will be discussed later.

A plurality of terminal apparatuses receive the control information broadcast by the access control apparatus 1010 and generate frames based on the control information. As a result, the frame generated by each of the plurality of terminal apparatuses is synchronized with the frame generated by the access control apparatus 1010. Also, slots generated by the respective plurality of terminal apparatuses are synchronized with each other. Each terminal apparatus performs carrier sensing in a plurality of slots, respectively, and estimates empty slots. Also, the terminal apparatus randomly selects one slot out of the empty slots. Also, the terminal apparatus broadcasts data using the selected slot. The terminal apparatus continues to select the same slots in corresponding timing in each frame, for a plurality of frames. It is to be appreciated that the terminal apparatus may broadcast data even when the terminal apparatus is not receiving control information. This is equivalent to a case where said terminal apparatus does not exist within the area 1200 formed by the access control apparatus 1010. In this case, the terminal apparatus performs CSMA/CA. The terminal apparatus, which has received data sent from the other terminal apparatuses, recognizes the presence of the vehicles carrying the other terminal apparatuses.

Note here that both the control information broadcast from the access control apparatus 1010 and the data broadcast from the terminal apparatuses use OFDM signals. However, it is not the same subcarriers in which the control information and the data are placed. The data is not placed in the aforementioned identification carriers. On the other hand, identification information is placed not only in the subcarriers where the data is placed but also in the identification carriers. As a result, even when there is a collision between data and identification information, the terminal apparatus can detect the presence of control information by observing the signal components of identification carriers. It should be noted that the aforementioned detection of entry into the area 1200 by the terminal apparatus may be made relative to the identification carriers.

Assume in FIG. 15 that the radio wave environment surrounding a terminal apparatus which is present within an area 1200 or the radio wave environment surrounding a terminal apparatus which is not present within the area 1200 deteriorates. When such a terminal apparatus detects that the radio wave environment is deteriorating, the terminal apparatus stores the degradation information. A method for detecting the degradation in radio wave environment will be discussed later. After the terminal apparatus has stored the degradation information, the transmission fails if the degradation information is transmitted immediately but the degradation in radio wave environment still continues. Thus, the terminal apparatus waits on standby for a predetermined period of time after it has stored the degradation information, and the terminal apparatus adds the degradation information to the data and transmits, by broadcast, the data. As for the timing, if the terminal apparatus is not present within the area 1200, the transmission of the degradation information may be further put on standby until the terminal apparatus enters the area 1200.

As the access control apparatus 1010 receives the data transmitted by broadcast by the terminal apparatus, the access control apparatus 1010 extracts the degradation information from the data. Also, the access control apparatus 1010 adds at least part of the degradation information to the control information and transmits the control information by broadcast. As other terminal apparatuses entering the area 1200 receive the control information sent from the access control apparatus 1010, they extract the degradation information from the control information if the degradation information is contained in the control information. The other terminal apparatuses notify the content of the degradation information of the driver. Further, as the other terminal apparatuses come closer to a periphery of the area indicated by the positional information, they reduce the frequency of transmitting the data.

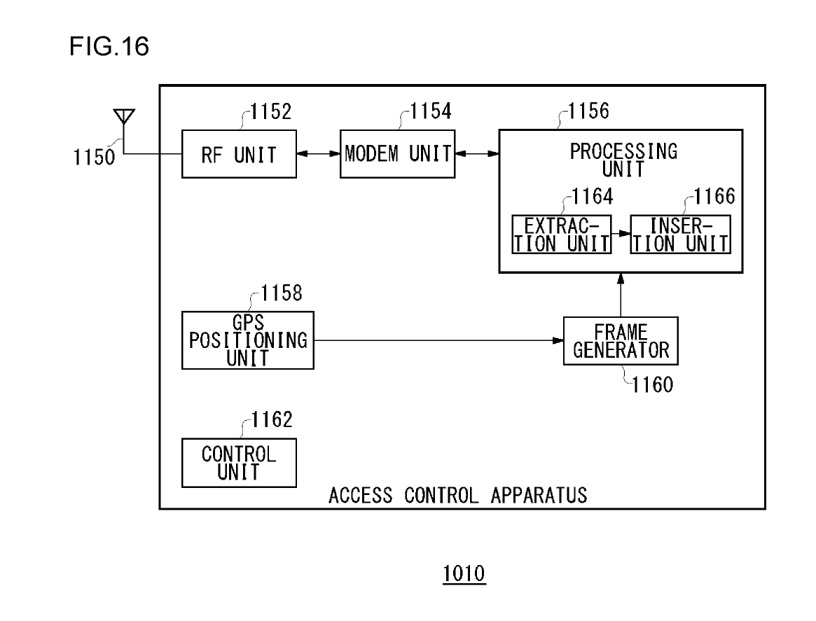

FIG. 16 shows a structure of the access control apparatus 1010. The access control apparatus 1010 includes an antenna 1150, an RF unit 1152, a modem unit 1154, a processing unit 1156, a GPS positioning unit 1158, a frame generator 1160, and a control unit 1162. The processing unit 1156 includes an extraction unit 1164 and an insertion unit 1166. The GPS positioning unit 1158 receives signals from not-shown GPS satellites and acquires information on the time of day based on the received signals. It should be noted that known art can be used for the acquisition of information on the time of day and therefore the description thereof is omitted here. The GPS positioning unit 1158 outputs the information on the time of day to the frame generator 1160.

The frame generator 1160 acquires information on the time of day from the GPS positioning unit 1158. The frame generator 1160 generates a plurality of frames based on the information on the time of day. For example, the frame generator 160 generates ten “100 msec” frames by dividing a duration of “1 sec” into 10 parts from the timing of “0 msec”. Frames are thus defined and specified repeatedly through the repetition of this process. Also, the frame generator 1160 generates a plurality of slots by dividing each frame into a plurality of parts. For example, dividing a frame into 200 parts generates 200 slots with each slot being “500 μsec” long.

Here, one or more of a plurality of slots contained in each frame is/are reserved as “control slots”. For example, first five slots from the beginning of 200 slots contained in each frame are control slots. Also, the control slot is a slot used when the access control apparatus 1010 broadcasts control information. The remaining slots of the plurality of slots in each frame are reserved and secured for the communications between not-shown terminal apparatuses. As previously indicated, since the communication system 1100 employs the OFDM modulation scheme, each slot is so specified as to be composed of a plurality of OFDM symbols. Also, an OFDM symbol comprises a guard interval (GI) and a valid symbol. Note that a guard time may be provided in the front portion and the rear portion of each slot. It is to be noted also that a certain group of or combination of a plurality of OFDM symbols contained in a slot is equivalent to the packet signal mentioned earlier.

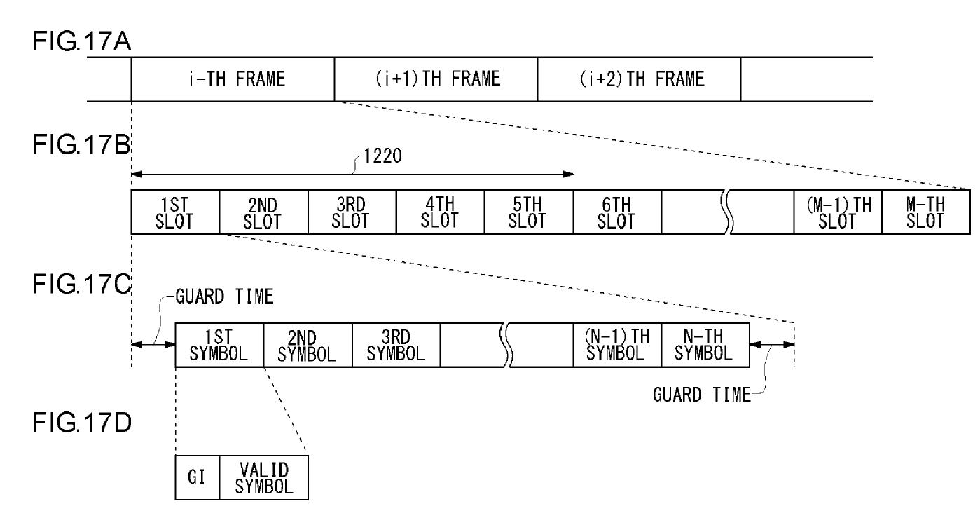

FIGS. 17A to 17D show the formats of frames generated by the frame generator 1160. FIG. 17A shows a structure of frames. As shown in FIG. 17A, a plurality of frames, such as i-th frame to (i+2)th frame, are so specified as to be repeated. Also, the duration of each frame is “100 msec”, for instance. FIG. 17B shows a structure of a single frame. As shown in FIG. 17B, a single frame consists of M units of slots. For example, M is “200” and the duration of each slot is “500 μsec”. Also, slots assigned to the beginning part of each frame correspond to the control slots, and an interval where the control slots are assigned is indicated as a control region 1220.

In this case, five slots which are a first slot to a fifth slot are contained in the control region 1220 as the control slots. FIG. 17C shows a structure of a single slot. As shown in FIG. 17C, a guard time may be provided in the front portion and the rear portion of each slot. And the remaining duration of the slot consists of N units of OFDM symbols. FIG. 17D shows a structure of each OFDM symbol. As shown in FIG. 17D, each OFDM symbol consists of a GI and a valid symbol. Let us now refer back to FIG. 16.

The RF unit 1152 receives through the antenna 1150 a packet signal transmitted in communication between the other terminal apparatuses (not shown) in each slot, as a receiving processing. Here, if it is specified in a manner such that the frame containing a plurality of slots as in FIG. 17A is repeated, the data is broadcast in cycles of frames, using a slot selected from among the plurality of slots. Also, data contains the identification number of a terminal apparatus which is a broadcast source. Thus the RF unit 1152 receives data from the terminal apparatus in cycles of frames. The RF unit 1152 performs a frequency conversion on the packet signal of a radiofrequency received through the antenna 150 and thereby generates a packet signal of baseband. Further, the RF unit 1152 outputs the baseband packet signal to the modem unit 1154. Generally, a baseband packet signal is formed of an in-phase component and a quadrature component, and therefore it should be represented by two signal lines. However, it is represented by a single signal line here to make the illustration clearer for understanding.

Also, the RF unit 1152 includes an LNA (Low Noise Amplifier), a mixer, an AGC unit, and an A-D conversion unit. As a transmission processing, the RF unit 1152 performs a frequency conversion on the baseband packet signal inputted from the modem unit 1154 and thereby generates a radiofrequency packet signal in each slot. Further, the RF unit 1152 transmits, through the antenna 1150, the radio frequency packet signal. The RF unit 1152 also includes a PA (Power Amplifier), a mixer, and a D-A conversion unit.

The modem unit 1154 demodulates the baseband packet signal fed from the RF unit 1152, as a receiving processing. Further, the modem unit 1154 outputs the demodulation result to the processing unit 1156. Also, the modem unit 1154 modulates the data fed from the processing unit 1156, as a transmission processing. Further, the modem unit 1154 outputs the modulation result to the RF unit 1152 as a baseband packet signal. It is to be noted here that the communication system 1100 is compatible with the OFDM modulation scheme and therefore the modem unit 1154 performs FFT (Fast Fourier Transform) as a receiving processing and performs IFFT (Inverse Fast Fourier Transform) as a transmission processing also.

The processing unit 1156 receives information on the timing of a frame and the timings of slots contained in the frame, from the frame generator 1160. The processing unit 1156 identifies the timings of control slots contained in a plurality of slots contained in the frame. In the case of FIG. 17A, the five control slots contained in the control region 1220 are identified. The processing unit 1156 performs carrier sensing on each slot via the antenna 1150, the RF unit 1152 and the modem unit 1154. Known art can be used as the carrier sensing and therefore the description thereof is omitted here. It is appreciated that the processing unit 1156 may receive the received signals from the RF unit 1152 without the signals being passed through the modem unit 1154. The processing unit 1156 selects one control slot out of the five control slots based on the carrier sensing result. For example, the control slot having the minimum interference power is selected.

The processing unit 1156 generates information on the selected control slot. Also, the processing unit 1156 generates control information by adding the control slot information and the identification information thereto. The processing unit 1156 assigns the control information to the selected control slot. The processing unit 1156 outputs the control information to the modem unit 1154, using the assigned control slot. Transmitting the control information using the control slot assigned by the communication system 1100 is equivalent to notifying the timing of control slots in a frame. Since the relative position of control slots in a frame is contained in the control slot information, said transmitting the control information using the control slot assigned by the communication system 1100 is also equivalent to notifying the timing of the frame. Here, the timing of frame corresponds to the timing to be synchronized when each terminal apparatus transmits data in the communications between the terminal apparatuses.

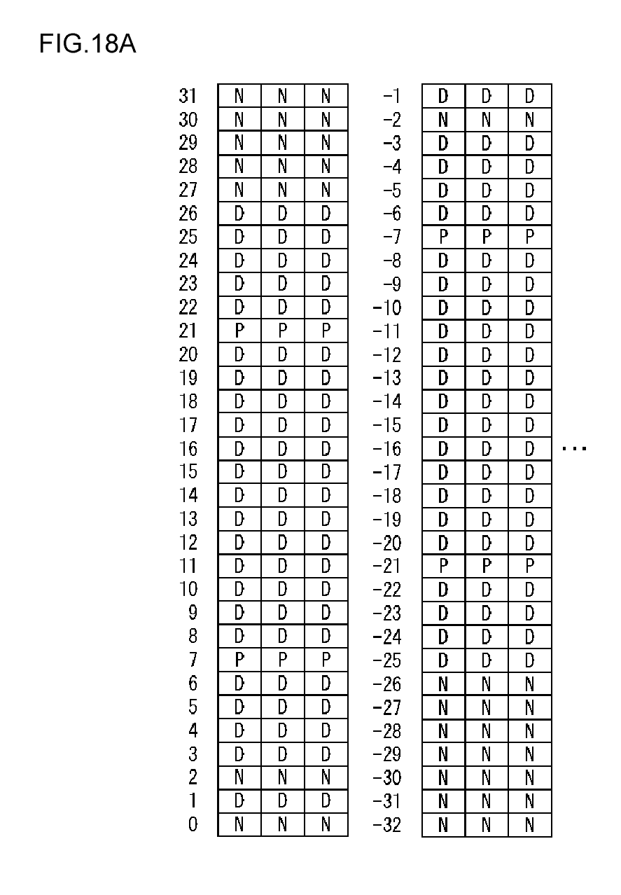

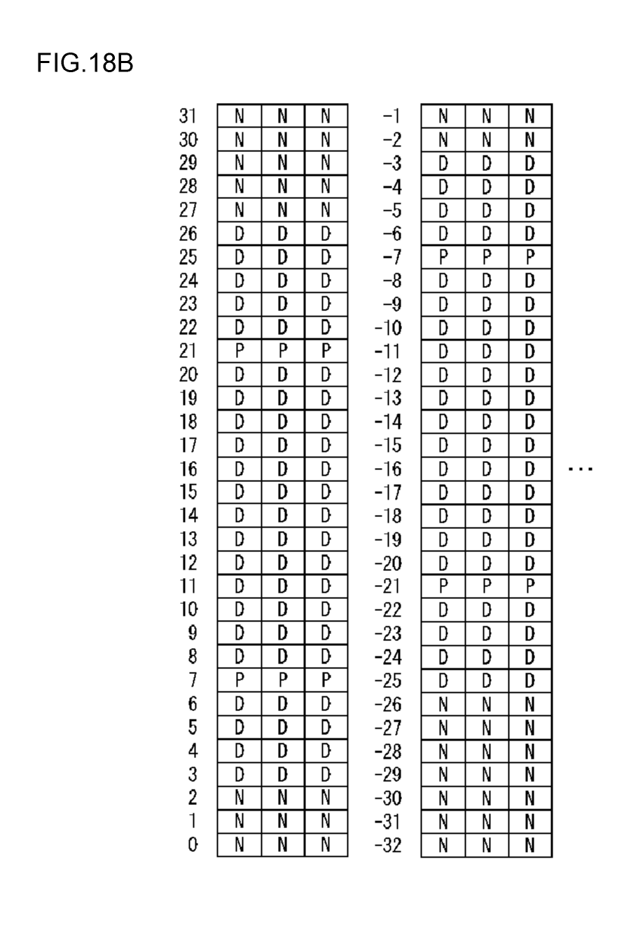

As described above, the communication system 1100 is compatible with the OFDM modulation scheme and therefore the processing unit 1156 generates the control information as an OFDM signal. Note here that the OFDM signals are also used for the communications between a not-shown plurality of terminal apparatuses. A description is given herein by comparing an OFDM signal that has the control information assigned (hereinafter this is sometimes called “control information” also) with an OFDM signal that has data assigned (hereinafter this is sometimes called “data” also). FIGS. 18A and 18B illustrate formats of OFDM symbols used in the communication system 1100. FIG. 18A corresponds to control information, whereas FIG. 18B corresponds to data.

In both FIG. 18A and FIG. 18B, the vertical direction represents the frequency, whereas the horizontal direction represents time. The numbers “31”, “30”, . . . , “−32” are indicated from top along the vertical direction, and these are the numbers assigned to identify subcarriers (hereinafter referred to as “subcarrier numbers”). In OFDM signals, the frequency of a subcarrier whose subcarrier number is “31” is the highest, whereas the frequency of a subcarrier whose subcarrier number is “−32” is the lowest. In FIG. 18A and FIG. 18B, “D” corresponds to a data symbol, “P” a pilot symbol, and “N” a null.

What are common to the control information and the data are the subcarrier numbers “31” to “27”, “2”, “0”, and “−2”, and the subcarrier numbers “−26” to “−32” which are all null. In the control information, the subcarrier numbers “26” to “3”, “−3” to “−25” are also used in data, and the use of symbols is the same for both the control information and the data. In the control information, on the other hand, the subcarrier numbers “1” and “−1” are not used for data. These correspond to the aforementioned identification carriers. That is, the identification carrier is assigned to a subcarrier near the center frequency of an OFDM signal. In the control information, a guard band is provided between a subcarrier used also for data and the identification carrier, namely between the subcarrier number “2” and the subcarrier number “−2”. The subcarriers of the subcarrier number “−2” through the subcarrier number “2” may be collectively called “identification carrier” or “identification carriers”.

Here, the processing unit 1156 assigns the information on frames and the slot numbers to the identification carrier. Also, the processing unit 1156 may preferentially assign information having higher degrees of importance to the identification carrier. Also, a known signal is assigned to an OFDM symbol which is located anterior to the packet signal. Such a known signal is used for AGC or used to estimate the channel characteristics. The processing unit 1156 may assign a known signal to the identification carrier over a partial period of a predetermined slot. Such a known signal is used as a unique word (UW), for example. Let us now refer back to FIG. 16.

The modem unit 1154 and the RF unit 1152 transmit, by broadcast, the control information generated by the processing unit 1156 from the antenna 1150, using the control slots. One of the destinations of the control information is a terminal apparatus. The terminal apparatus having received the control information recognizes the timing of each slot and uses at least one of the remaining slots reserved for the communications between terminal apparatuses. If the terminal apparatus broadcasts the data over a plurality of frames, the terminal apparatus will use the same slots in corresponding timing in each frame.

The processing unit 1156, the antenna 1150, the RF unit 1152 and the modem unit 1154 receives the data broadcast from a not-shown terminal apparatus. If the degradation information is contained in the data received by the processing unit 1156, the extraction unit 1164 will extract the degradation information. Though information contained in the degradation information will be described later, the degradation information contains at least a detection result that the radio wave environment is deteriorating and the positional information on a location where the radio wave environment is deteriorated. The extraction unit 1164 outputs the extracted degradation information to the insertion unit 1166.

The insertion unit 1166 receives the degradation information from the extraction unit 1164. The insertion unit 1166 instructs the processing unit 1156 to insert the degradation information to the control information. Note that it is not necessary to insert all of information contained in the degradation information to the control information and it is only necessary that at least part of information is inserted to the control information. In so doing, the detection result that there is a location where the radio wave environment is deteriorated and the positional information on the location where the radio wave environment is deteriorated are at least contained to clarify where the deteriorating radio wave environment is located. The insertion unit 1166 does not need to insert directly the degradation information received from a single terminal apparatus. Instead, a plurality of items of degradation information may be subjected to statistical processing so as to generate new degradation information and then the insertion unit 1166 may insert this new degradation information to the control information.

Note here that a plurality of items of degradation information may be those received from a plurality of terminal apparatuses, information received from a single terminal apparatus a plurality of times, or a combination of these. For example, if the insertion unit 1166 receives the information on positions included in a section of a predetermined size a predetermined number of times or more for a predetermined period of time, it will be determined that the radio wave environment in the section is deteriorating. The predetermined period of time may be set to one second, for instance. The predetermined size may be defined as a circle of radius 100 m, for instance. The predetermined number of times may be defined as ten times, for instance. And these predetermined values may be derived beforehand through experiments, simulation runs and the like.

Further, the insertion unit 1166 generates, from the positional information received a predetermined number of times or more, positional information corresponding to their center points, and adds the thus generated positional information to the new degradation information. Since the degradation information that does not meet the above conditions is discarded by the insertion unit 1166, the degree of accuracy of the degradation information which is to be inserted to the data improves. As described above, the processing unit 1156 also transmits, by broadcast, the control information containing the degradation information via the modem unit 1154, the RF unit 1152 and the antenna 1150. The control unit 1162 controls the processing of the access control apparatus 1010 as a whole.

These structural components may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

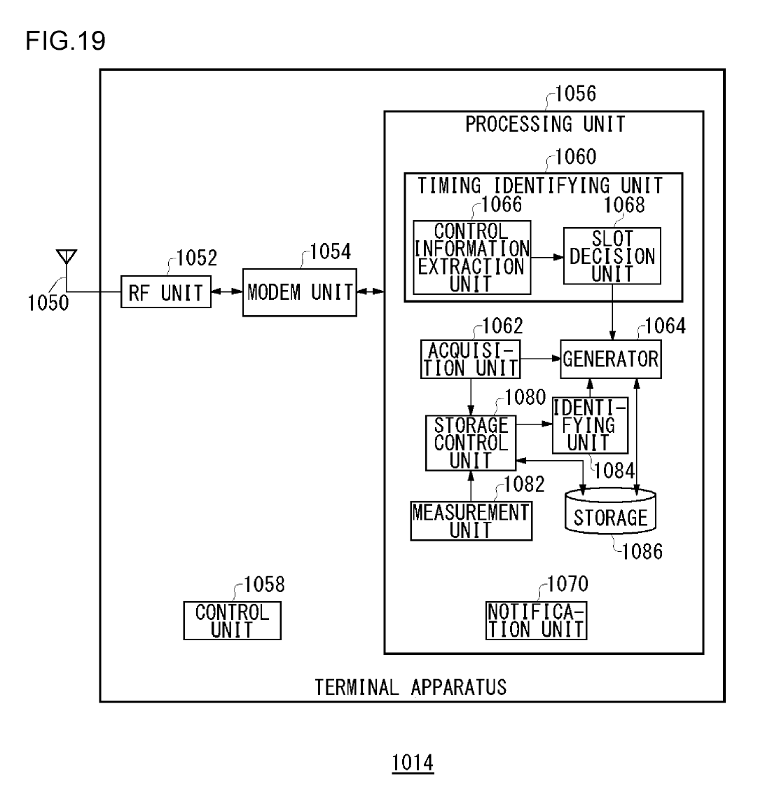

FIG. 19 shows a structure of a terminal apparatus 1014 mounted on a vehicle 1012. The terminal apparatus 1014 includes an antenna 1050, an RF unit 1052, a modem unit 1054, a processing unit 1056, and a control unit 1058. The processing unit 1056 includes a timing identifying unit 1060, an acquisition unit 1062, a generator 1064, a storage control unit 1080, a measurement unit 1082, an identifying unit 1084, a storage, and a notification unit 1070. The timing identifying unit 1060 includes a control information extraction unit 1066 and a slot decision unit 1068. The antenna 1050, the RF unit 1052 and the modem unit 1054 carry out the processings similar to those carried out by the antenna 1150, the RF unit 1152 and the modem unit 1154 of FIG. 16, respectively. Thus, the repeated description thereof is omitted here.

The acquisition unit 1062 includes a GPS receiver, a gyroscope, a vehicle speed sensor, and so forth all of which are not shown in FIG. 19. The acquisition unit 1062 acquires the present position, traveling direction, traveling speed and so forth of a not-shown vehicle 1012, namely the vehicle 1012 carrying the terminal apparatus 1014, based on data supplied from the aforementioned not-shown components of the acquisition unit 1062. The present position thereof is indicated by the latitude and longitude. Known art may be employed to acquire them and therefore the description thereof is omitted here. The acquisition unit 1062 outputs the thus acquired information to the generator 1064.

The control information extraction unit 1066 receives the demodulation result fed from the modem unit 1054. Of the demodulation result, the control information extraction unit 1066 monitors a part of subcarriers corresponding to the identification carrier. If valid data is contained in the part of subcarriers corresponding to the identification carrier, the control information extraction unit 1066 will recognize that the control information extraction unit 1066 is receiving a slot containing the control information therein, namely a control slot. Also, the control information extraction unit 1066 establishes the synchronization between frames and slots when the timing with which the slot containing the control information is received is used as a reference.

More specifically, the control information extraction unit 1066 identifies the control slots where the received demodulation result is assigned, based on the control slot information contained in the control information. Then the control information extraction unit 1066 generates frames with this identified control slot as a reference. If the control information corresponds to a third slot as shown in the FIG. 17B, the control information extraction unit 1066 will generate frames with the third slot as a reference. In other words, the control information extraction unit 1066 generates frames each containing a plurality of slots in such a manner as to synchronize with the frame corresponding to the control slot information. This corresponds to that the control information extraction unit 1066 extracts, from the control information, information on the timing of a frame and the timings of slots contained in the frame. The control information extraction unit 1066 outputs information on the thus generated frames to the slot decision unit 1068

The slot decision unit 1068 measures, by carrier sensing, the interference power for each of a plurality of slots contained in the frame generated by the control information extraction unit 1066. Also, the slot decision unit 1068 estimates empty slots based on the interference powers. More specifically, the slot decision unit 1068 stores a predetermined threshold value in advance, and compares the interference power at each slot against the threshold value. The slot decision unit 1068 estimates slots whose interference powers are below the threshold value, as empty slots, and randomly identifies one of the estimated empty slots. Note that the slot decision unit 1068 may identify a slot whose interference power is the minimum. As a result, the slot decision unit 1068 determines a slot which is synchronized with the control slot information and which arrives in cycles of frames. If the control information is not extracted by the control information extraction unit 1066, the slot decision unit 1068 will determine the transmission timing by performing CSMA/CA. The slot decision unit 1068 conveys the identified slot and the determined transmission timing to the generator 1064.

The generator 1064 generates data in such manner as to add the information, acquired by the acquisition unit 1062, to the data. That is, the generator 1064 generates data that contains the measured present position. The generator 1064 transmits, by broadcast, the data via the modem unit 1054, the RF unit 1052, and antenna 1050, using the slot identified by the slot decision unit 1068. This is equivalent to that data is transmitted, by broadcast, with the timing based on the control information, if the control information is received. If, on the other hand, the control information is not received, the data is transmitted, by broadcast, with the transmission timing determined by the slot decision unit 1068.

The measurement unit 1082 measures the radio wave environment in the communication unit. Though any techniques may be used to measure the radio wave environment, the following (1) to (3) are measured. Note that one of (1) to (3) or the combination of any two of (1) to (3) may be executed. As (1), the measurement unit 1082 receives the data received by the RF unit 1052 and the data demodulated by the modem unit 1054. Note that the data received by the RF unit 1052 may be data of radiofrequency or data of baseband. The measurement unit 1082 measures the received power of the received data and measures the quality of the demodulated data. To measure the received power, the measurement unit 1082 calculates an average value of the received powers within a frequency domain of the OFDM symbols. To measure the quality of the demodulated data, the measurement unit 1082 derives the error rate or EVM. The measurement unit 1082 outputs the combination of the received power and the quality to the storage control unit 1080.

As (2), the measurement unit 1082 monitors whether or not the degradation information is contained in the data received from other terminal apparatuses 1014. If the degradation information is contained therein, the measurement unit 1082 will output a detection result indicating that the degradation information is contained therein, to the storage control unit 1080. As (3), the measurement unit 1082 measures a period of time during which a slot is not identified or the transmission timing is not determined by the slot decision unit 1068 (hereinafter referred to as “transmission failed period”). The transmission failed period corresponds to a period during which data cannot be broadcast. The measurement unit 1082 outputs the transmissions failed period to the storage control unit 1080.

The storage control unit 1080 determines if the radio wave environment measured by the measurement unit 1082 is deteriorated. For (1), if the received power is larger than a threshold value for power and is more deteriorated than a threshold value for quality, the storage control unit 1080 will identify the degradation of the radio wave environment. For (2), if the degradation information is contained, the storage control unit 1080 will identify the degradation of the radio wave environment. For (3), if the transmission failed period is longer than a threshold value for period, the storage control unit 1080 will identify the degradation of the radio wave environment. Here, if the degradation of the radio wave environment is identified in one of (1) to (3), the storage control unit 1080 will determine the degradation of the radio wave environment. As the degradation of the radio wave environment is determined, the storage control unit 1080 receives, from the acquisition unit 1062, the present position at the determined timing, as the positional information.

The storage control unit 1080 stores the combination of the received positional information and the detection result that there is a location where the radio wave environment deteriorates, in the storage 1086. The combination of these corresponds to the “degradation information”. Note that information other than these may be contained in the degradation information. For example, identification information of an access control apparatus 1010 that is to cover the positional information, a cause of degradation of radio wave environment, the time of day, and so forth may be contained in the degradation information. Here, if the control information is received at the time the degradation of the radio environment has been determined, the identification information of an access control apparatus 1010 that is to cover the positional information will be equivalent to the identification information of an access control apparatus 1010 which is a broadcast source of this control information. The cause(s) of degradation of radio wave environment correspond to items where the degradation of radio wave environments in (1) to (3) is identified in the storage control unit 1080.

The storage 1086 is a storage medium such as a hard disk and stores the degradation information according to instructions given from the storage control unit 1080. The identifying unit 1084 identifies the timing with which the degradation information stored in the storage 1086 is to be broadcast. If the storage control unit 1080 stores the degradation information in the storage 1086, the identifying unit 1084 will receive a notification from the storage control unit 1080. Upon receipt of the notification, the identifying unit 1084 starts a timer. Also, the identifying unit 1084 sets a predetermined period of time, and the timer identifies timing at which the predetermined period of time has elapsed (hereinafter, the timing set accordingly will be referred to as “first broadcast timing”). The identifying unit 1084 outputs the thus identified timing to the generator 1064.

With the processing carried out by the identifying unit 1084, the timing with which the degradation information is broadcast lags the timing with which the degradation information is stored. By shifting the timing as described above, the possibility that the radio wave environment is suppressed improves. As a result, the possibility that the degradation information is broadcast with degradation of the radio wave environment suppressed improves. Also, even though the degradation of the radio wave environment is detected outside the area 1200 of FIG. 15, the possibility that the broadcast source may have entered the area 1200 after the predetermined period of time has elapsed is high.

Also, the identifying unit 1084 may employ another method to identify the timing with which to broadcast the timing. The identifying unit 1084 receives the notification from the storage control unit 1080 and also receives the positional information. The positional information may be positional information contained in the degradation information or positional information newly acquired by the acquisition unit 1062. Then the identifying unit 1084 receives periodically the present position from the acquisition unit 1062, and thereby derives the distance measured from a spot where the storage 1086 has stored the degradation information. Also, the identifying unit 1084 sets a predetermined distance and identifies the timing at which the broadcast source moves the predetermined distance (hereinafter the timing identified accordingly will be referred to as “second broadcast timing”). The identifying unit 1084 outputs the identified timing to the generator 1064 as the timing to be broadcast. In this case, the timing is identified based on the distance from the position where the degradation of the radio wave environment has been detected, so that the degradation information is broadcast at a position distant from the position where the degradation of the radio environment has been detected. As a result, the similar effect to the above-described effect is achieved.

The identifying unit 1084 may employ still another method to identify the timing with which to be broadcast. The identifying unit 1084 receives the notification from the storage control unit 1080. After having received the notification, the identifying unit 1084 also receives the control information received by the control information extraction unit 1066. The identifying unit 1084 identifies timing with which the control information sent from a new access control apparatus 1010 has been received (hereinafter the timing identified accordingly will be referred to as “third broadcast timing”). The timing with which the control information sent from the new access control apparatus 1010 is thought of as timing at which a new area 1200 approaches. As a result, the similar effect to the above-described effect is achieved.

As the generator 1064 receives the timing identified by the identifying unit 1084, the generator 1064 extracts the degradation information from the storage 1086. Also, the generator 1064 adds the degradation information to the data. Then, as described above, the generator 1064 transmits, by broadcast, the data via the modem unit 1054, the RF unit 1052, and the antenna 1050, with the timing determined by the slot decision unit 1068, using the slot identified by the slot decision unit 1068. If the identified timing is the first broadcast timing or second broadcast timing, the generator 1064 may wait on standby for a transmission of the data containing the degradation information until it enters the area 1200.

Even though the identifying unit 1084 identifies the timing, there are cases where the period of time until when the data containing the degradation information is transmitted by broadcast becomes longer. As the period of time until when the data containing the degradation information is transmitted by broadcast becomes longer, the reliability of the degradation information is low due to variation of radio wave environment. To cope with this, the generator 1064 carries out the processing as follows. The generator 1064 generates data containing the degradation information and also measures a period of time that has elapsed after the data has been generated, by starting the timer. Also, the identifying unit 1084 sets beforehand a predetermined period of time separately from the predetermined period of time set by the identifying unit 1084, and determines the stop of transmitting by broadcast the degradation information with timing with which the predetermined period of time has elapsed (hereinafter the timing determined accordingly will be referred to as “first stop timing”).

The generator 1064 may employ still another method to identify the timing with which to stop the broadcasting of the degradation information. The generator 1064 generates data containing the degradation information and also acquires the present position at the time from the acquisition unit 1062. Then the generator 1064 receives periodically the present position from the acquisition unit 1062, and thereby derives the distance from the position where the data containing the degradation information has been generated. Also, the generator 1064 sets beforehand a predetermined distance separately from the predetermined distance set by the identifying unit 1084, and determines the stop of transmitting by broadcast the degradation information with timing with which the predetermined distance has been moved (hereinafter the timing determined accordingly will be referred to as “second stop timing”).

The generator 1064 may employ still another method to determine the stop of transmitting by broadcast the degradation information. The generator 1064 generates data containing the degradation information and then receives the control information extracted by the control information extraction unit 1066. The generator 1064 determines the stop of transmitting by broadcast the degradation information with timing with which a predetermined number of pieces of control information, sent from the new access control apparatus 1010, have been received (hereinafter the timing determined accordingly will be referred to as “third stop timing”).

The notification unit 1070 acquires the data sent from not-shown other terminal apparatuses 1014 and conveys the approach or the like of the not-shown other vehicles 1012 to the driver via a monitor or speaker according to the content of the data, in each slot with predetermined timing. Now, if a detection result indicating that the degradation information has been detected is contained in the control information, the notification unit 1070 will convey the detection result accordingly. For example, the notification unit 1070 displays characters like “the radio wave environment deteriorates near XXXX” to draw attention. The driver, who has been informed of such information, can recognize the possibility that the data is not conveyed normally. Also, as the terminal apparatus 1014 comes closer to the position indicated by the degradation information, the generator 1064 and the like may reduce the frequency of transmitting the data. The control unit 1058 controls the entire operation of the terminal apparatus 1014.

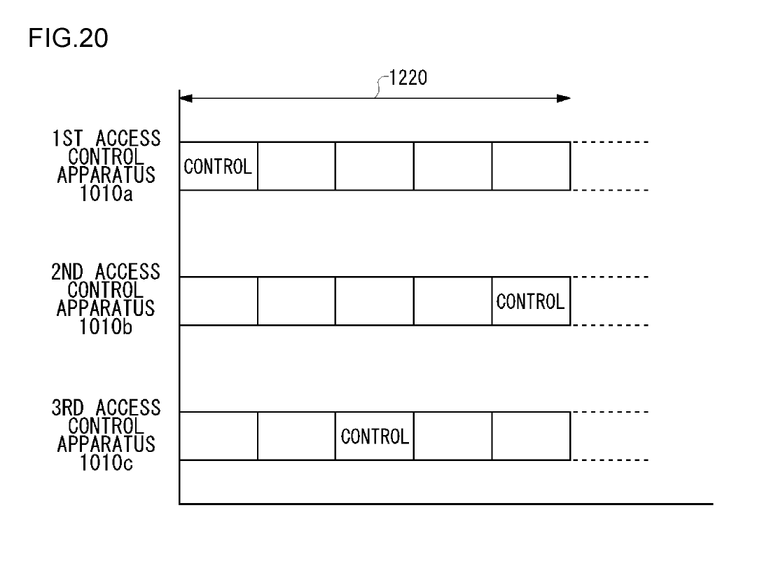

An operation of the communication system 1100 configured as above is now described. FIG. 20 shows an operational overview of the communication system 1100. The horizontal direction of FIG. 20 corresponds to time, and the first access control apparatus 1010a to the third access control apparatus 1010c are indicated along the vertical direction of FIG. 20. Only the control region 1220 in FIG. 17B is shown in FIG. 20. As described earlier, assumed herein that five control slots are assigned to the control region 1220. “Control” in FIG. 20 indicates control information. The first access control apparatus 1010a uses the leading control slot. The second access control apparatus 1010b uses the fifth control slot. The third access control apparatus 10c uses the third control slot. As a result, the interference among the control information transmitted by broadcast from the respective access control apparatuses 1010 is reduced.

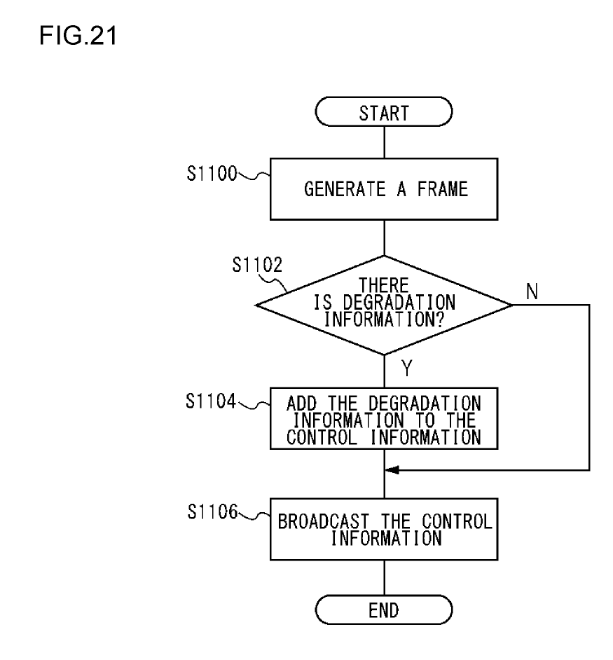

FIG. 21 is a flowchart showing a procedure in which the control information is broadcast by the access control apparatus 1010. The frame generator 1160 generates frames (S1100). If there is degradation information (Y of S1102), the processing unit 1156 will add the degradation information to the control information (S1104). If there is no degradation information (N of S1102), Step S1104 will be skipped. The processing unit 1156, the modem unit 1154, the RF unit 1152 and the antenna 1150 broadcast the control information (S1106).

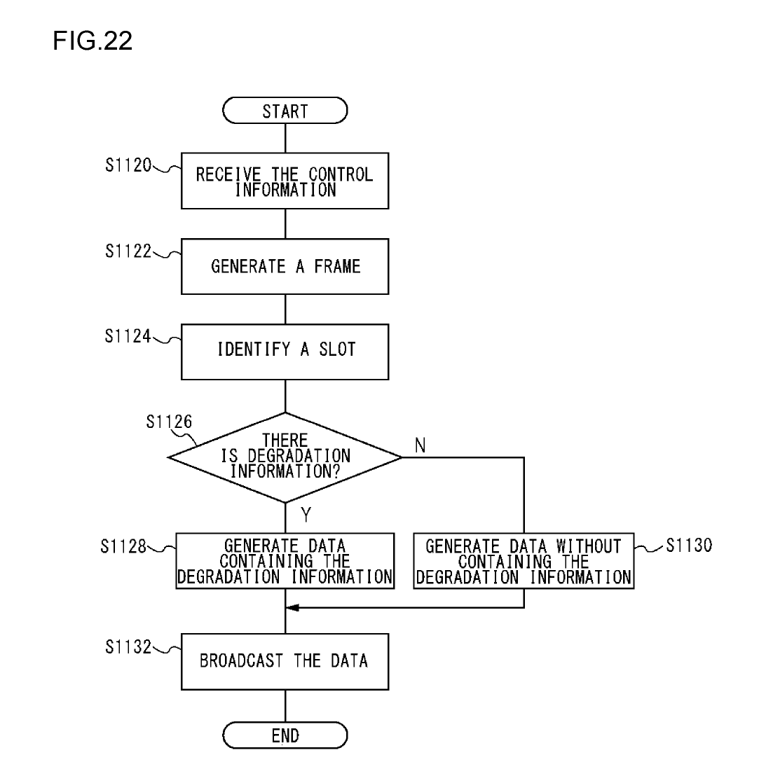

FIG. 22 is a flowchart showing a procedure in which data is broadcast by a terminal apparatus 1014. The control information extraction unit 1066 receives the control information (S1120) and generates frames (S1122). Then the slot decision unit 1068 identifies a slot (S1124). If there is degradation information (Y of S1126), the generator 1064 generates data containing the degradation information (S1128). If, on the other hand, there is no degradation information (N of S1126), the generator 1064 generates data without containing the degradation information (S1130). The processing unit 1056, the modem unit 1054, the RF unit 1052 and the antenna 1050 broadcast the data (S1132).

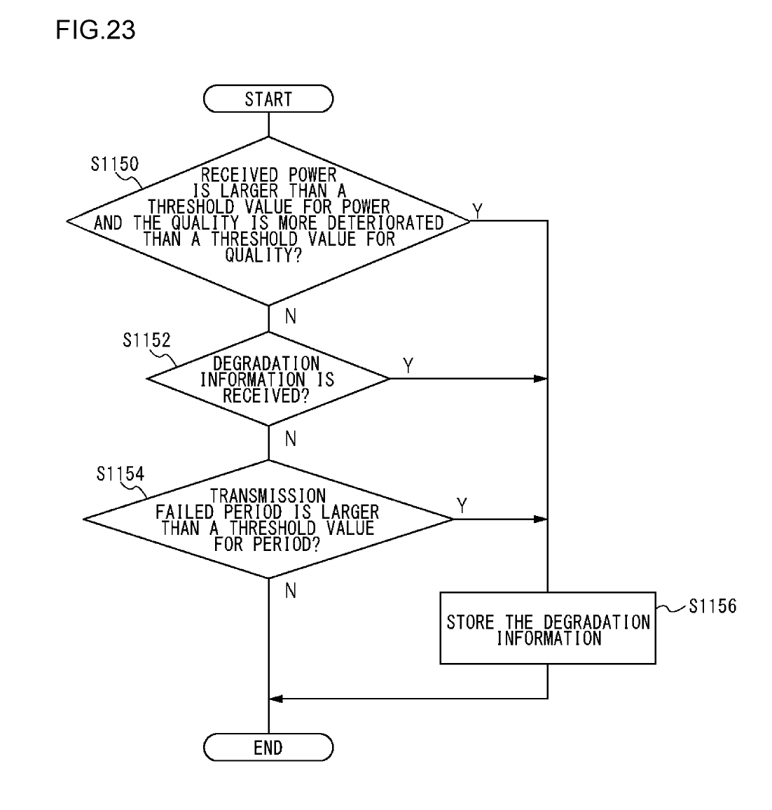

FIG. 23 is a flowchart showing a procedure in which the degradation information is stored by the terminal apparatus 1014. If the received power measured by the measurement unit 1082 is larger than the threshold value for power and the quality measured by the measurement unit 1082 is more deteriorated than the threshold value for quality (Y of S1150), the storage control unit 1080 will store the degradation information in the storage 1086 (S1156). If either the received power measured by the measurement unit 1082 is not larger than the threshold value for power or the quality measured by the measurement unit 1082 is not more deteriorated than the threshold value for quality (N of S1150) and if the measurement unit 1082 receives the degradation information (Y of S1152), the storage control unit 1080 will store the degradation information in the storage 1086 (S1156). If the measurement unit 1082 does not receive the degradation information (N of S1152) and if the transmission failed period measured by the measurement unit 1082 is larger than the threshold value for period (Y of S1154), the storage control unit 1080 will store the degradation information in the storage 1086 (S1156). If the transmission failed period measured by the measurement unit 1082 is not larger than the threshold value for period (N of S11564), the processing will be terminated.

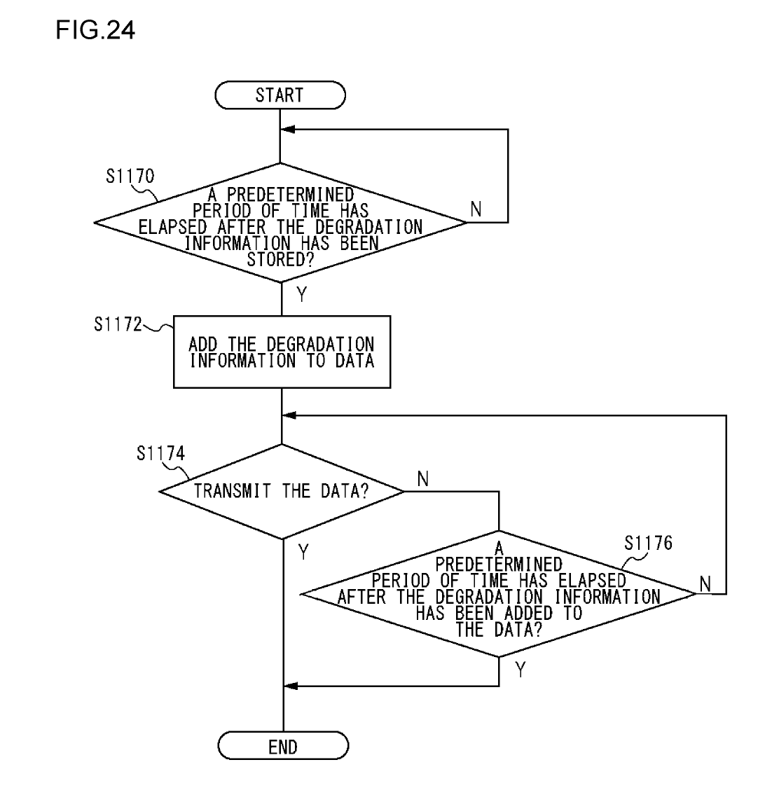

FIG. 24 is a flowchart showing a procedure in which the degradation information is managed by the terminal apparatus 1014. This corresponds to case where the above-described first broadcast timing and first stop timing are applied. If a predetermined period of time does not elapse after the degradation information has been stored (N of S1170), the identifying unit 1084 will wait on standby (N of S1170). If, on the other hand, the predetermined period of time elapses after the degradation information has been stored (Y of SS170), the identifying unit 1084 will add the degradation information to the data (S1172). If the processing unit 1056 and the like transmit the data (Y of S1174), the processing will be terminated. If the processing unit 1056 and the like do not transmit the data (N of S1174) and if a predetermined time does not elapse after the degradation information has been added to the data (N of S1176), return to Step S1174. If the predetermined period of time elapses after the degradation information has been added to the data (Y of S1176), the processing will be terminated.

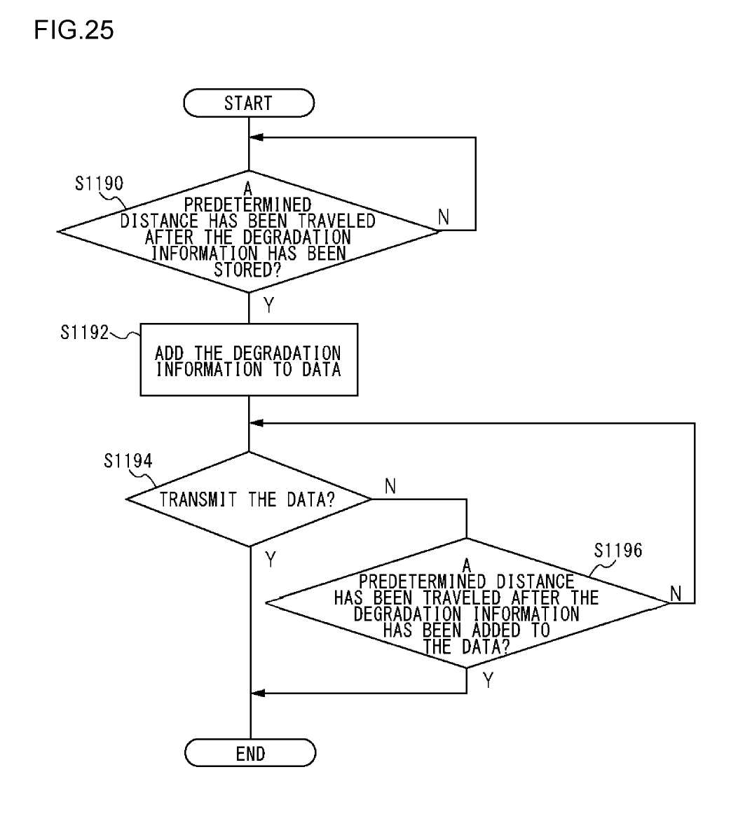

FIG. 25 is a flowchart showing another procedure in which the degradation information is managed by the terminal apparatus 1014. This corresponds to case where the above-described second broadcast timing and second stop timing are applied. If a predetermined distance is not traveled after the degradation information has been stored (N of S1190), the identifying unit 1084 will wait on standby (N of S1190). If, on the other hand, the predetermined distance is traveled after the degradation information has been stored (Y of S1190), the identifying unit 1084 will have the generator 1064 add the degradation information to the data (S1192). If the processing unit 1056 and the like transmit the data (Y of S1194), the processing will be terminated. If the processing unit 1056 and the like do not transmit the data (N of S1194) and if a predetermined distance is not traveled after the degradation information has been added to the data (N of S1196), return to Step S1194. If the predetermined distance is traveled after the degradation information has been added to the data (Y of S1196), the processing will be terminated.

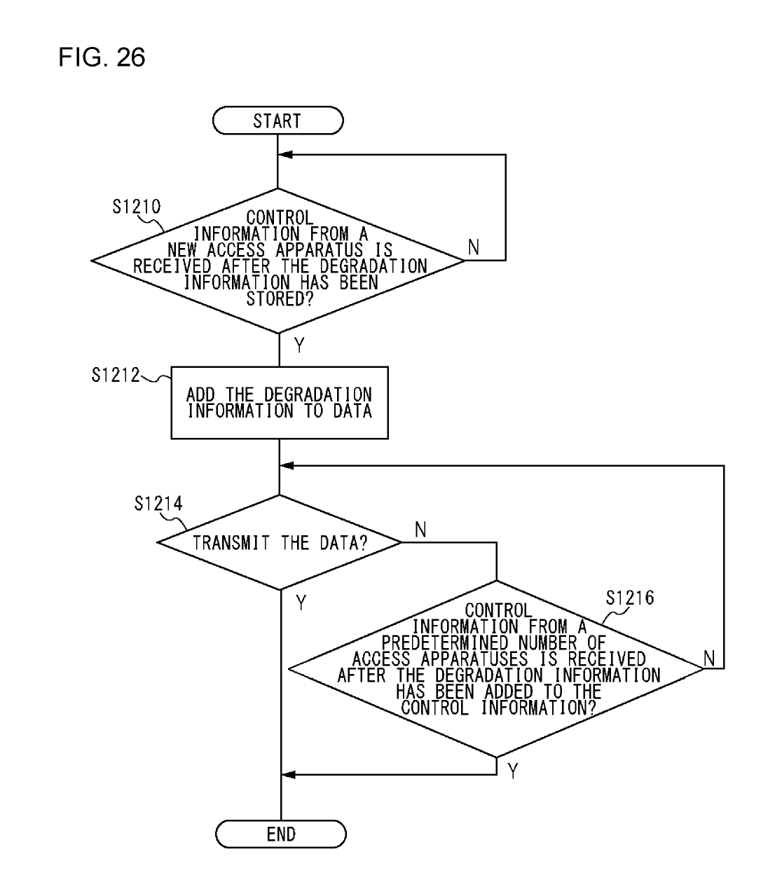

FIG. 26 is a flowchart showing still another procedure in which degradation information is managed by the terminal apparatus 1014. This corresponds to case where the above-described third broadcast timing and third stop timing are applied. If control information from a new access control apparatus 1010 is not received after the degradation information has been stored (N of S1210), the identifying unit 1084 will wait on standby (N of S1210). If, on the other hand, control information from a new access control apparatus 1010 is received after the degradation information has been stored (Y of S1210), the identifying unit 1084 will have the generator 1064 add the degradation information to the data (S1212). If the processing unit 1056 and the like transmit the data (Y of S1214), the processing will be terminated. If the processing unit 1056 and the like do not transmit the data (N of S1214) and if the control information from a predetermined number of access control apparatuses 1010 is not received after the degradation information has been added to the data (N of S1216), return to Step S1214. If the control information from a predetermined number of access control apparatuses 1010 is received after the degradation information has been added to the data (Y of S1216), the processing will be terminated.

Still another modification is now described. Similar to the another modification, the still another modification relates to a communication system 1100 including an access control apparatus 1010 and terminal apparatuses 1014. In the another modification, the access control apparatus 1010 broadcasts the timing of a frame and the degradation information, using the control information. According to this still another modification, on the other hand, the access control apparatus 1010 broadcasts frames by adding still another information to the control information for the purpose of further reducing the collision probability of data. The access control apparatus 1010 identifies slots not used in communication among a plurality of terminal terminals (hereinafter referred to as “empty slots” or “unused slots”) by measuring the received power in each slot. Note that those which may be assigned as the empty slots are those excluding the control slots. The access control apparatus 1010 identifies slots having any collision (hereinafter referred to as “collision slots”) by also measuring in each slot for any collision of packet signals transmitted by the plurality of terminal apparatuses. Note also that those which may be identified as the collision slots are those excluding the control slots.

The access control apparatus 1010 also adds information on the identified empty slots and the identified collision slots to the control information. A terminal apparatus 1014 estimates empty slots based on the control information, and randomly selects a slot out of the empty slots. Further, the terminal apparatus 1014 transmits, by broadcast, the data using the selected slot. The communication system 1100 according to the still another modification is of similar type to those described in conjunction with FIG. 15 and FIG. 19. A description is given here centering around features different from those described in conjunction with FIG. 15 and FIG. 19.

FIG. 24 shows a structure of the access control apparatus 1010 according to still another modification. The access control apparatus 1010 includes an antenna 1020, an RF unit 1022, a modem unit 1024, a processing unit 1026, a GPS positioning unit 1028, and a control unit 1030. The processing unit 1026 includes a detecting unit 1032, a frame specifying unit 1034, a generator 1036, a selector 1110, an extraction unit 1164, and an insertion unit 1166. The detecting unit 1032 includes a power measuring unit 1038, a quality measuring unit 1040, an empty slot identifying unit 1042, and a collision slot identifying unit 1044. The antenna 1020, the RF unit 1022, the modem unit 1024, the GPS positioning unit 1028, the control unit 1030, the frame specifying unit 1034, the extraction unit 1164, and the insertion unit 1166 correspond respectively to the antenna 1150, the RF unit 1152, the modem unit 1154, the GPS positioning unit 1158, the control unit 1162, the frame generator 1160, the extraction unit 1164, and the insertion unit 1166, and therefore the repeated description thereof is omitted here. In particular, a description of the detection and broadcasting of degradation information are omitted here.

The selector 1110 performs carrier sensing on each slot of the respective plurality of control slots in the control region 1220, and selects one control slot out of them based on the carrier sensing result. Since the processing performed by the selector 1110 is similar to that performed by the processing unit 1156 of FIG. 16, the description thereof is omitted here. The selector 1110 outputs information on the selected control slot to the generator 1036.

The power measuring unit 1038 receives a received signal from the RF unit 1022 or the modem unit 1024 and measures the received power. Note that the received power is measured slot by slot. Also, slots correspond to slots other than the control slots. Hence, the power measuring unit 1038 measures the received power for each of the plurality of slots. The power measuring unit 1038 outputs the received power for each slot to the empty slot identifying unit 1042 and the collision slot identifying unit 1044. The quality measuring unit 1040 receives the demodulation result from the modem unit 1024 and measures the signal quality for each of the plurality of slots. The signal quality measured herein is the error rate. Here, slots correspond to slots other than the control slots, too. It should be noted that known art can be used for the measurement of the error rate, so that the description thereof is omitted here. Also, instead of the error rate, EVM (Error Vector Magnitude) or the like may be measured as the signal quality. The quality measuring unit 1040 outputs the error rate to the collision slot identifying unit 1044.

The empty slot identifying unit 1042 receives the received power for each slot from the power measuring unit 1038. The empty slot identifying unit 1042 compares each received power against a threshold value (hereinafter referred to as “threshold value for empty slot”) and identifies the slot for which the received power is smaller than the threshold value for empty slot. That is, the empty slot identifying unit 1042 detects, from among a plurality of slots other than those contained in the control region 1220, a slot that can be used in communication among a plurality of terminal apparatuses, as an empty slot. Note here that when there are a plurality of empty slots, the empty slot identifying unit 1042 identifies them as empty slots. The empty slot identifying unit 1042 outputs information on the identified empty slots to the generator 1036.

The collision slot identifying unit 1044 receives the received power for each slot from the power measuring unit 1038 and receives the error rate for each slot from the quality measuring unit 1040. Also, the collision slot identifying unit 1044 associates the received power with the error rate, slot by slot. The collision slot identifying unit 1044 not only compares the received power against a first threshold value, but also compares the error rate against a second threshold value, slot by slot. The collision slot identifying unit 1044 identifies, as a collision slot, a slot for which the received power is larger than the first threshold value and at the same time the error rate is higher than the second threshold value. That is, the collision slot identifying unit 1044 recognizes, as a collision slot, a slot for which the received power is large but the communication quality is inferior. In this manner, the collision slot identifying unit 1044 detects, as a collision slot, a slot in which a collision has occurred due to duplicate transmission of signals sent from a plurality of terminal apparatuses. The collision slot identifying unit 1044 outputs information on the identified collision slots to the generator 1036.

The generator 1036 receives information on empty slots from the empty slot identifying unit 1042 and also receives information on collision slots from the collision slot identifying unit 1044. The generator 1036 generates control information by adding the information on empty slots and the information on collision slots thereto. Note here that the numbers, 1, 2, . . . from the start (hereinafter referred to as “slot numbers”) are given respectively to a plurality of slots contained in a frame. The generator 1036 adds the slot number(s) of the empty slot(s) contained in the previous frame(s) as information on empty slots to the control information. Further, as the generator 1036 receives the degradation information, the generator 1036 stores this information in the control information, too. Also, the generator 1036 receives information on frames and slots from the frame specifying unit 1034. The generator 1036 periodically assigns the control information to any one of control slots. The generator 1036 outputs the control information to the modem unit 1024, using the thus assigned control slot.

In the another modification, the slot decision unit 1068 of the terminal apparatus 1014 estimates empty slots based on the carrier sensing result. According to the still another modification, in contrast thereto, the slot decision unit 1068 estimates empty slots based on the information on empty slots and/or the information on collision slots contained in the control information. A description is given herein of processing performed by the terminal apparatus 1014 according to the still another modification.

The control information extraction unit 1066 receives the control information fed from the modem unit 1054. The control information extraction unit 1066 acquires the information on empty slots and the information on collision slots from the control information. The control information extraction unit 1066 outputs the information on empty slots and the information on collision slots to the slot decision unit 1068. The slot decision unit 1068 receives the information on empty slots and the information on collision slots from the control information extraction unit 1066. The slot decision unit 1068 selects empty slot(s) from among the slots excluding those of the control region 1220 in each frame.

While such processing continues, the control information extraction unit 1066 continues to extract the information on empty slots and the information on collision slots, from the control information, frame by frame. Based on the information on collision slots, the slot decision unit 1068 checks to see if any of the slot numbers corresponding to the slots in current use is mistaken as a collision slot. If no slot is mistaken as a collision slot, the slot decision unit 1068 will continue to output the same slot numbers as before to the generator 1064. If, on the other hand, any slot is mistaken as a collision slot, the slot decision unit 1068 will again estimate empty slots based on the information on empty slots. In other words, the slot decision unit 1068 repeats the previous processing.

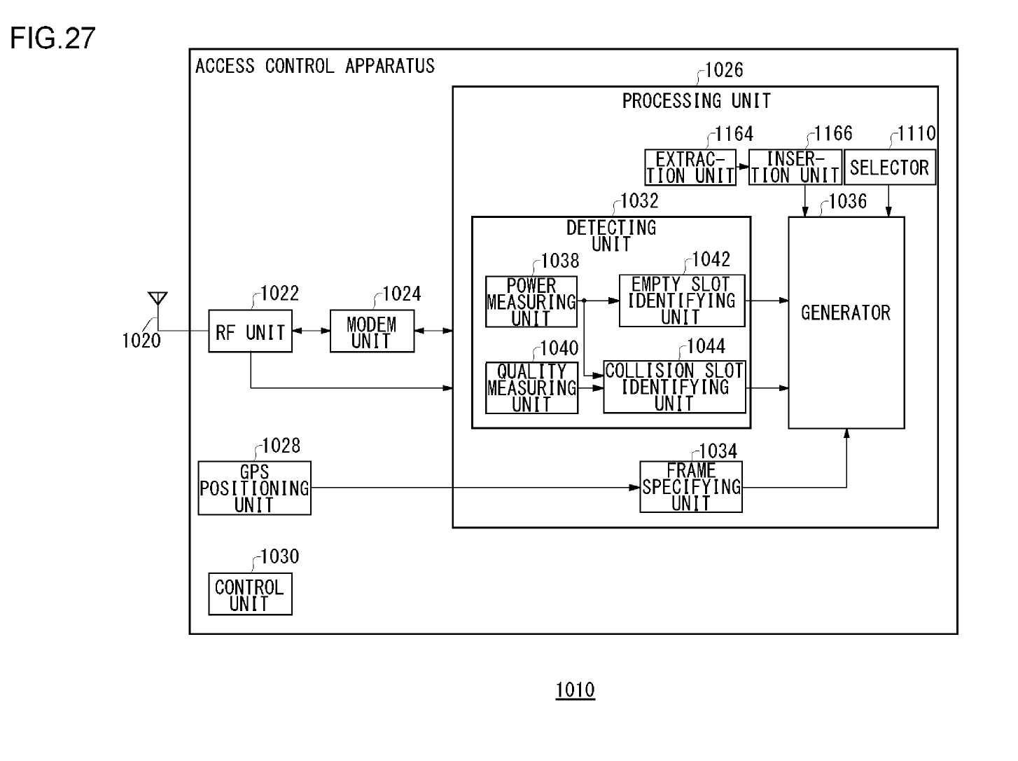

If the control information received by the control information extraction unit 1066 does not contain the information on empty slots, the slot decision unit 1068 may execute the operation described in the another modification. This corresponds to a case where broadcast is not the control information from the access control apparatus 1010 of FIG. 27 but the control information from the access control apparatus 1010 of FIG. 16. In this case, the slot decision unit 1068 performs carrier sensing on each of a plurality of slots contained in the frame generated by the control information extraction unit 1066. If the control information extraction unit 1066 does not receive the information on empty slots, the slot decision unit 1068 will estimate empty slots based on the carrier sensing execution result.

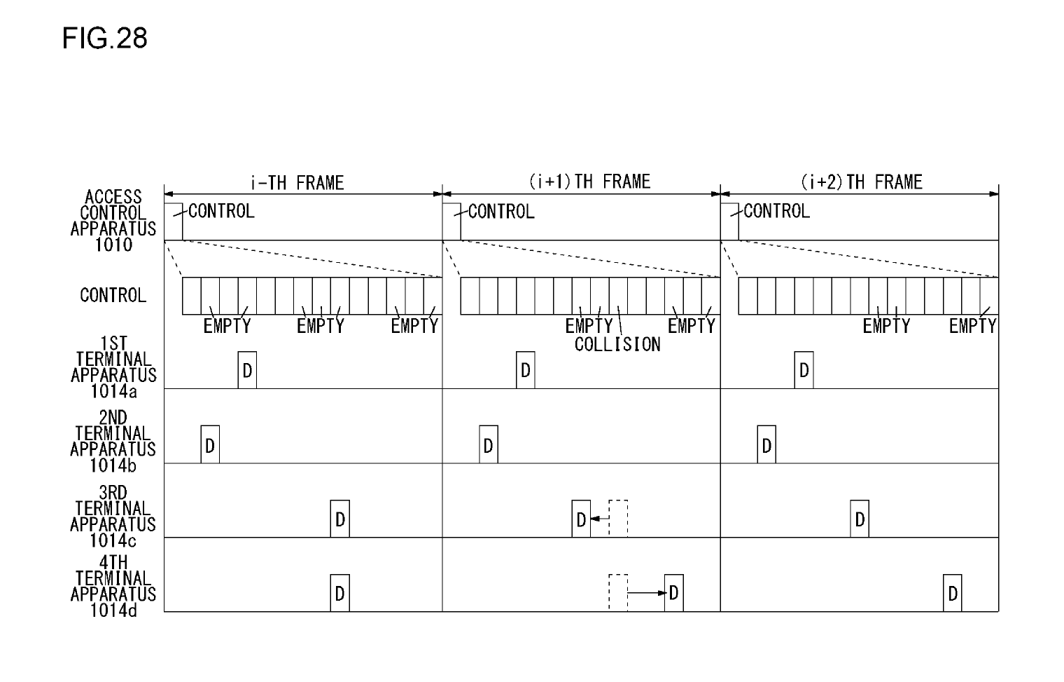

FIG. 28 shows an operational overview of the communication system 1100 according to the still another modification. The horizontal direction of FIG. 11 corresponds to time, and three frames that are an ith frame to an (i+2)th frame are indicated as described in the top row. Assume herein for the clarity of description that the number of control slots contained in each frame is one and each frame contains 15 slots. As shown in FIG. 28, the access control apparatus 1010 broadcasts the control information using the leading slot of each frame. “Control” in FIG. 28 indicates control information. Below “control”, information on empty slots and information on collision slots both contained in the control information are indicated by associating them with slots. “Empty” in FIG. 28 indicates an empty slot, whereas “collision” in FIG. 11 indicates a collision slot.

In the rows below the top row, the timings with which the first terminal apparatus 1014a to the fourth terminal apparatus 1014d broadcast the data are indicated. “D” in FIG. 28 means data. The first terminal apparatus 1014a to the fourth terminal apparatus 1014d each references the control information and selects an empty slot. The first terminal apparatus 1014a to fourth terminal apparatus 14d each broadcasts the data using the selected empty slot in the ith frame. Since the empty slot selected by the third terminal apparatus 1104c is identical to the empty slot selected by the fourth terminal apparatus 1014d, the data broadcast from them collide with each other. The access control apparatus 1010 detects the occurrence of collision in said slot. The control information, broadcast from the access control apparatus 1010, in the (i+1)th frame indicates the slot where the collision occurs, as the information on the collision slot.

Since no collision occurs in the slots used by the first terminal apparatus 1014a and the second terminal apparatus 1014b, the slots having the same slot numbers are used again. On the other hand, since collision has occurred in the slots used by the third terminal apparatus 1014c and the fourth terminal apparatus 1014d, different empty slots are selected again. The third terminal apparatus 1014c and the fourth terminal apparatus 1014d broadcast the data, using the selected empty slots. Since not all of data collides, the collision slots are not indicated in the control information, broadcast from the access control apparatus 1010, in the (i+2)th frame. Thus, the first terminal apparatus 1014a to the fourth terminal apparatus 1014d use again the slots, having the same slot numbers as the slots used already, in the (i+2)th frame.

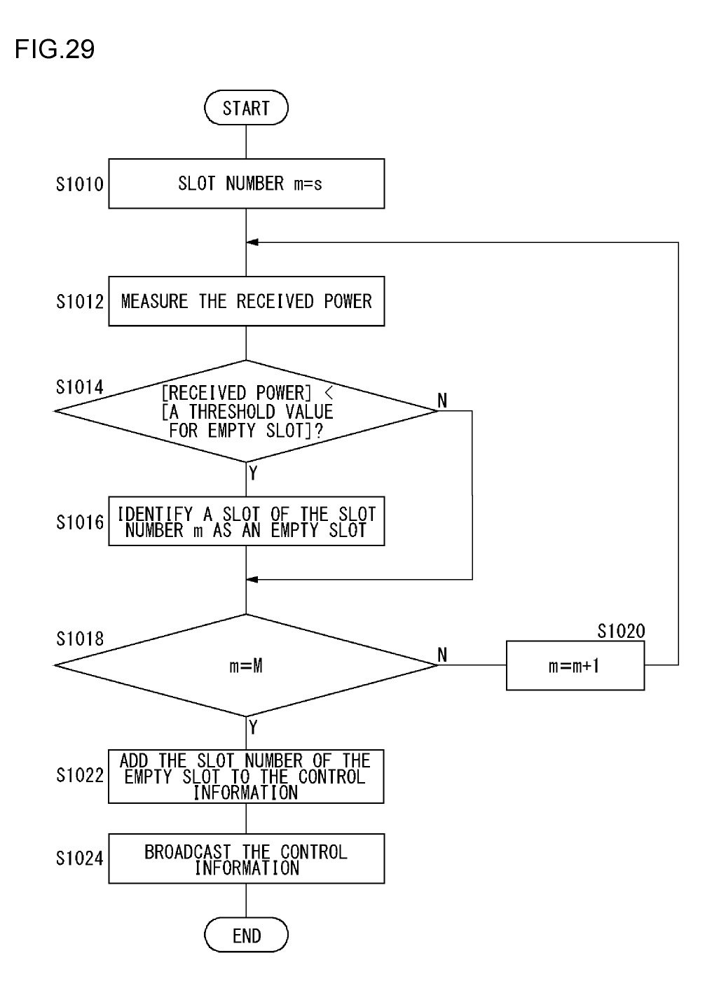

FIG. 29 is a flowchart showing a procedure in which the access control apparatus 1010 conveys an empty slot. The detecting unit 1032 sets the slot number m to “s” (S1010). The power measuring unit 1038 measures the received power (S1012). If the received power is less than the threshold value for empty slot (Y of S1014), the empty slot identifying unit 1042 will identify the slot of the slot number m as an empty slot (S1016). If the received power is not less than the threshold value for empty slot (N of S1014), the empty slot identifying unit 1042 will skip the process of Step S1016. If the slot number m is not equal to the maximum number M (N of S1018), the detecting unit 1032 will increment the slot number m by 1 (S1020) and the process will return to Step S1012. If, on the other hand, the slot number m is the maximum number M (Y of S1018), the generator 1036 will add the slot number of the empty slot to the control information (S1022). The modem unit 1024 and the RF unit 1022 broadcast the control information (S1024).

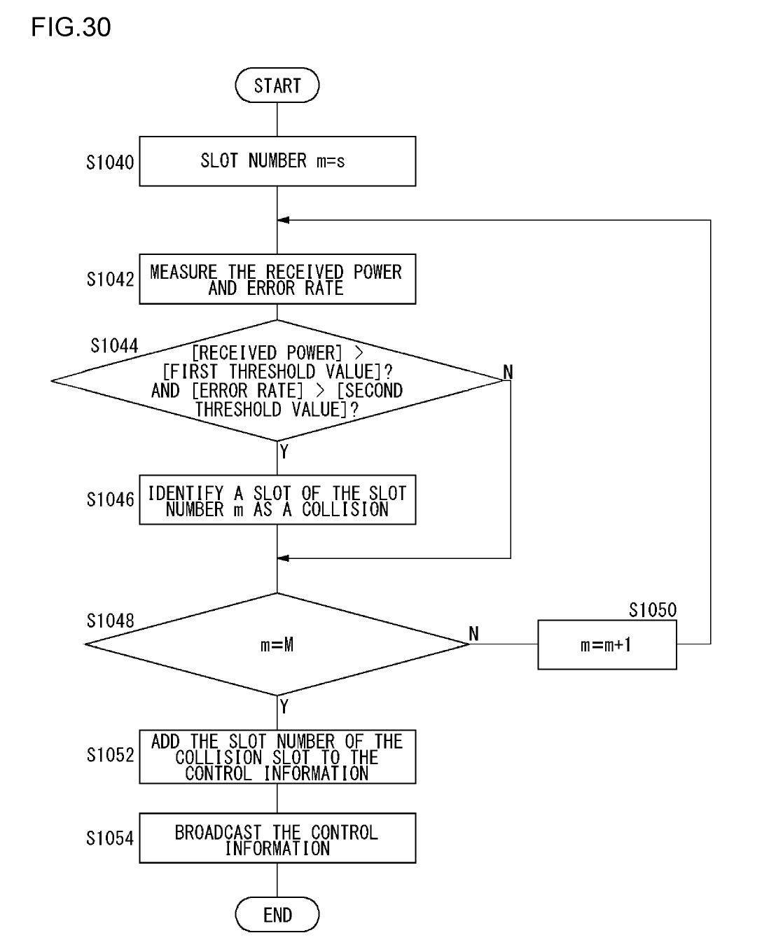

FIG. 30 is a flowchart showing a procedure in which the access control apparatus 1010 conveys a collision slot. The detecting unit 1032 sets the slot number m to “s” (S1040). The power measuring unit 1038 measures the received power, and the quality measuring unit 1040 measures the error rate (S1042). If the received power is greater than the first threshold value and the error rate is greater than the second threshold value (Y of S1044), the collision slot identifying unit 1044 will identify the slot of the slot number m as a collision slot (S1046). If the received power is not greater than the first threshold value or the error rate is not greater than the second threshold value (N of S1044), the collision slot identifying unit 1044 will skip the process of Step S1046. If the slot number m is not equal to the maximum number M (N of S1048), the detecting unit 1032 will increment the slot number m by 1 (S1050) and the process will return to Step S1042. If, on the other hand, the slot number m is the maximum number M (Y of S1048), the generator 1036 will add the slot number of the collision slot to the control information (S1052). The modem unit 1024 and the RF unit 1022 broadcast the control information (S1054).

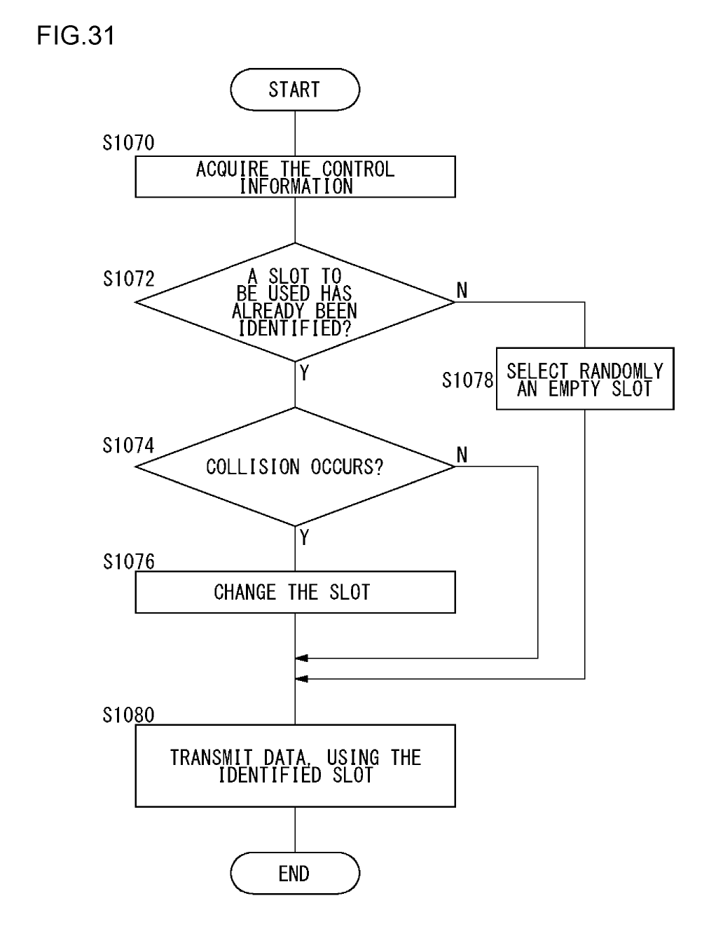

FIG. 31 is a flowchart showing a data transmission procedure performed by the terminal apparatus 1014 according to still another modification. The control information extraction unit 1066 acquires the control information (S1070). If a slot to be used has already been identified (Y of S1072), the slot decision unit 1068 will verify whether collision occurs in this slot or not. If collision occurs (Y of S1074), the slot decision unit 1068 will change the slot (S1076). If no collision occurs (N of S1074), Step S1076 will be skipped. If, on the other hand, a slot to be used has not already been identified (N of S1072), the slot decision unit 1068 will estimate empty slots and then randomly identify an empty slot (S1078). The generator 1064 transmits the data, using the thus identified slot (S1080).

By employing the exemplary embodiments of the present invention, a disturbing signal, if any, is detected and informed accordingly, so that the presence of the disturbing signal can be brought to the attention of drives. Also, since the presence of the disturbing signal is brought to the attention of drivers, the possibility that the data may not be received normally can be estimated. Also, since the possibility that the data may not be received normally is estimated, degradation of driving safety can be suppressed. Also, since the possibility that the data may not be received normally is estimated, the adverse effect that may be caused by the disturbing signal can be reduced. Also, the signal which is not synchronous with the timing of each slot and whose quality has been deteriorated continuously for a certain period of time is regarded as the disturbing signal, so that the degree of accuracy in detecting the disturbing signals can be improved. Also, the signal whose degree of movement is low is detected as the disturbing signal, so that the disturbing signals which are present fixedly in an area can be detected.

Data is broadcast using the slots generated according to the control information conveyed from the access control, so that synchronization can be established between a plurality of terminal apparatuses. Also, since synchronization can be established between a plurality of terminal apparatuses, the collision probability of data can be reduced. Also, since the data is broadcast within slots, the occurrence of situations where parts of a plurality of data overlap and thereby collide with each other can be reduced. Also, since the data is broadcast within slots, the usage efficiency of frame can be improved. Also, empty slots are estimated and any of them is/are selected, so that the collision probability of packet signals can be reduced even when the communication volume has increased. Also, the empty slots are estimated based on the carrier sensing result, so that the empty slots suitable for the surroundings of a terminal apparatus can be estimated.

Also, the empty slots are estimated based on the control information, so that the empty slots suitable for the surroundings of the access control apparatus can be estimated. Also, carrier sensing is performed if the information on empty slots is not contained in the control information, so that the processing according to various access control apparatuses can be carried out. Also, the identification carriers in the control information are not used for data, whereas the remaining subcarriers are also used for data. Thus, even if the control information and data signals collide, the presence of the control information can be detected by observing the signal components of the control information. Also, the guard band is provided between the identification carrier and the other subcarriers, so that the interference therebetween can be reduced and the probability of arrival of information transmitted using the identification carriers can be improved. Also, important information is assigned to the identification carrier, so that the probability of arrival of important information can be improved. Also, the UW is assigned to the identification carrier, so that the degree of accuracy in detecting the identification carriers can be improved.

Also, the control region is reserved for control slots in a plurality of slots contained in each frame. Thus, the interference between the control information and the data can be reduced. Also, a plurality of control slots are assigned to the control region, so that the interference between a plurality of pieces of control information from a plurality of access control apparatuses can be reduced. Also, since the interference therebetween is reduced, the deterioration in the quality of the control information can be suppressed. Also, since the deterioration in the quality of the control information is suppressed, the contents of control information can be transmitted accurately. Also, since the interference between a plurality of pieces of control information is reduced, a plurality of access control apparatuses can be installed. Also, since a plurality of access control apparatuses are installed, the collision probability of packet signals occurring at each intersection can be reduced. Also, control slots not used by other access control apparatuses are estimated, so that the interference between a plurality of pieces of control information can be reduced.

Also, the slots usable in communication between a plurality of terminal apparatuses are broadcast from among a plurality of slots. Thus the probability of collisions occurring in communication between the plurality of terminal apparatuses can be reduced. Also, since the probability of collisions occurring in communication between the plurality of terminal apparatuses is reduced, the collision probability of packet signals under the conditions of increased volume can be reduced. Also, empty slots are identified based on the received powers of a plurality of slots, respectively, so that the empty slots can be easily identified. Also, the slot number of an empty slot which is contained in a previous frame is broadcast, so that the instructions to the terminal apparatuses can be executed reliably. Also, a terminal apparatus, which is using the empty slot, uses a slot that corresponds to said slot, over a plurality of frames, so that the processing can be simplified. Also, the access control apparatus does not directly participate in the data communication between terminal apparatuses but only conveys a parameter related to the empty slots. Hence, the structure and operation according to the exemplary embodiments and embodiments are easily applicable to a communication system premised on CSMA/CA, too.

Also, the slot in which a collision has occurred due to duplicate transmission of signals from the plurality of terminal apparatuses is broadcast. Thus, the probability of collisions occurring in communication between the plurality of terminal apparatuses can be reduced. Also, the collision slots are identified based on the received powers of the plurality of slots, respectively, and the signal qualities of the plurality of slots, respectively, so that the collision slots can be easily identified. Also, the slot number of a collision slot which is contained in a previous frame is broadcast, so that the instructions to the terminal apparatuses can be executed reliably. Also, the access control apparatus does not directly participate in the data communication between terminal apparatuses but only conveys a parameter related to the collision slots. Hence, the structure and operation according to the exemplary embodiments and embodiments are easily applicable to a communication system premised on CSMA/CA, too.

Also, the positional information is stored when the radio wave environment degrades, and the positional information is broadcast as the degradation information with broadcast timing. Thus, the positional information on an area where the radio wave environment degrades can be informed. Also, the degradation information is not broadcast right after the degradation information has been stored. Thus, the possibility that the transmission of the degradation information may fail due to the degradation of the radio wave environment can be reduced. Also, the degradation information is broadcast after a certain period of time has elapsed after the degradation information has been stored. Thus, the possibility that the degradation can be notified increases. Also, the degradation information is broadcast after a certain distance is traveled after the degradation information has been stored. Thus, the possibility that the degradation information can be notified increases. Also, the degradation information is broadcast after the broadcast source has been traveled to an area formed by a new access control apparatus after the degradation information has been stored. Thus, the possibility that the degradation information can be notified increases. Also, since the degradation information is broadcast after the broadcast source has been traveled to an area formed by a new access control apparatus after the degradation information has been stored, the degradation information can be conveyed to the access control apparatus. Also, even when the degradation of the radio wave environment is detected outside the area, the degradation information is conveyed to the access control apparatus. Thus, the communications outside the area by the access control apparatus can be controlled.

Also, as the access control apparatus received the gradation information, the access control apparatus broadcasts the control information containing the degradation information. Thus the degradation information can be conveyed to terminal apparatuses entering the area where the radio wave environment has been deteriorated. Also, since the degradation information is received before entering the area where the radio wave environment has been deteriorated, the entering of a terminal apparatus into the area where the radio wave environment has been deteriorated can be predicted. Also, since the entering into the area where the radio wave environment is notified, so that the entering into the area where the radio wave environment can be brought to the attention of the driver. If the data is not transmitted even when a certain period of time elapses after the data containing the degradation information has been generated, the data will be discarded. Thus, drop in the reliability of the degradation information can be suppressed. Also, if the data is not transmitted even when the broadcast source enters the area formed by a predetermined number of access control apparatuses, the data will be discarded. Thus, drop in the reliability of the degradation information can be suppressed.

Also, data is broadcast using the slots generated according to the control information conveyed from the access control, so that synchronization can be established between a plurality of terminal apparatuses. Also, since synchronization can be established between a plurality of terminal apparatuses, the collision probability of data can be reduced. Also, since the data is broadcast within slots, the occurrence of situations where parts of a plurality of data overlap and thereby collide with each other can be reduced. Also, since the data is broadcast within slots, the usage efficiency of frame can be improved. Also, empty slots are estimated and any of them is/are selected, so that the collision probability of packet signals can be reduced even when the communication volume has increased. Also, the empty slots are estimated based on the carrier sensing result, so that the empty slots suitable for the surroundings of a terminal apparatus can be estimated.

Also, the empty slots are estimated based on the control information, so that the empty slots suitable for the surroundings of the access control apparatus can be estimated. Also, carrier sensing is performed if the information on empty slots is not contained in the control information, so that the processing according to various access control apparatuses can be carried out. Also, the identification carriers in the control information are not used for data, whereas the remaining subcarriers are also used for data. Thus, even if the control information and data signals collide, the presence of the control information can be detected by observing the signal components of the control information. Also, the guard band is provided between the identification carrier and the other subcarriers, so that the interference therebetween can be reduced and the probability of arrival of information transmitted using the identification carriers can be improved. Also, important information is assigned to the identification carrier, so that the probability of arrival of important information can be improved. Also, the UW is assigned to the identification carrier, so that the degree of accuracy in detecting the identification carriers can be improved.

Also, the control region is reserved for control slots in a plurality of slots contained in each frame. Thus, the interference between the control information and the data can be reduced. Also, a plurality of control slots are assigned to the control region, so that the interference between a plurality of pieces of control information from a plurality of access control apparatuses can be reduced. Also, since the interference therebetween is reduced, the deterioration in the quality of the control information can be suppressed. Also, since the deterioration in the quality of the control information is suppressed, the contents of control information can be transmitted accurately. Also, since the interference between a plurality of pieces of control information is reduced, a plurality of access control apparatuses can be installed. Also, since a plurality of access control apparatuses are installed, the collision probability of packet signals occurring at each intersection can be reduced. Also, control slots not used by other access control apparatuses are estimated, so that the interference between a plurality of pieces of control information can be reduced.

Also, the slots usable in communication between a plurality of terminal apparatuses are broadcast from among a plurality of slots. Thus the probability of collisions occurring in communication between the plurality of terminal apparatuses can be reduced. Also, since the probability of collisions occurring in communication between the plurality of terminal apparatuses is reduced, the collision probability of packet signals under the conditions of increased volume can be reduced. Also, empty slots are identified based on the received powers of a plurality of slots, respectively, so that the empty slots can be easily identified. Also, the slot number of an empty slot which is contained in a previous frame is broadcast, so that the instructions to the terminal apparatuses can be executed reliably. Also, a terminal apparatus, which is using the empty slot, uses a slot that corresponds to said slot, over a plurality of frames, so that the processing can be simplified. Also, the access control apparatus does not directly participate in the data communication between terminal apparatuses but only conveys a parameter related to the empty slots. Hence, the structure and operation according to the exemplary embodiments and embodiments are easily applicable to a communication system premised on CSMA/CA, too.

Also, the slot in which a collision has occurred due to duplicate transmission of signals from the plurality of terminal apparatuses is broadcast. Thus, the probability of collisions occurring in communication between the plurality of terminal apparatuses can be reduced. Also, the collision slots are identified based on the received powers of the plurality of slots, respectively, and the signal qualities of the plurality of slots, respectively, so that the collision slots can be easily identified. Also, the slot number of a collision slot which is contained in a previous frame is broadcast, so that the instructions to the terminal apparatuses can be executed reliably. Also, the access control apparatus does not directly participate in the data communication between terminal apparatuses but only conveys a parameter related to the collision slots. Hence, the structure and operation according to the exemplary embodiments and embodiments are easily applicable to a communication system premised on CSMA/CA, too.

The present invention has been described based on the exemplary embodiments. The exemplary embodiments are intended to be illustrative only, and it is understood by those skilled in the art that various modifications to constituting elements and processes as well as arbitrary combinations thereof could be further developed and that such modifications and combinations are also within the scope of the present invention.

In the exemplary embodiments of the present invention, the frame generator 160 specifies frames each of which is constituted by a plurality of slots. However, this should not be considered as limiting and, for example, the frame generator 160 may provide periods (fields) other than the plurality of slots, in each frame. More specifically, a plurality of slots may be assigned in a partial period of a frame, whereas the CSMA/CA scheme may be used in communication between a plurality of terminal apparatuses 14 in the remaining periods. In such a case, the access control apparatus does not detect the empty slots and the collision slots while the CSMA/CA scheme is in use. According to this modification, each terminal apparatus 14 can select the communication mode between a communication using slots and a communication using the CSMA/CA scheme. Hence, the degree of freedom in communications can be increased. In other words, it suffices that each frame at least contains a plurality of slots.

In the exemplary embodiments of the present invention, the control information broadcast from the access control apparatus 10 and the data broadcast from a terminal apparatus 14 are each assigned to a single slot. However, this should not be considered as limiting and, for example, the control information and the data may each be assigned to two or more slots. According to this modification, the transmission rate of control information and data can be increased.

In the exemplary embodiments of the present invention, an identification carrier is equivalent to two subcarriers. Also, the identification carrier is assigned to the subcarriers near the center frequency of an OFDM symbol. However, this should not be considered as limiting and, for example, the identification carrier may be equivalent to more than two subcarriers. For example, the identification carrier may be assigned to subcarriers other than those near the center frequency of an OFDM symbol. In such a case, the information on empty slots and/or the information on collision slots may be added to the identification carriers. According to this modification, the communication system 100 can be designed more freely.

In the exemplary embodiments of the present invention, the first identifying unit 166a, the second identifying unit 166b, and the third identifying unit 166c are provided as the identifying unit 166. However, this should not be considered as limiting and, for example, the first identifying unit 166a and the second identifying unit 166b only may be provided as the identifying unit 166. In this case, the processing concerning the degree of movement is skipped. According to this modification, the processing can be simplified.

The decision unit 168 identifies the presence of a disturbing signal and conveys this detection result of the presence of a disturbing signal to the processing unit 156. However, this should not be considered as limiting and, for example, the decision unit 168 may identify the frequency which is not much affected by the disturbing signal, in addition to the present of a disturbing signal. In this case, the identifying unit 166 or the decision unit 168 derives the spectrum of the received signal. Also, the decision unit 168 extracts a frequency, in the spectra, whose power density is lower than a predetermined value. The extracted frequency band corresponds to the “frequency which is not much affected by the disturbing signal. The predetermined value is preferably determined beforehand through experiments and simulation runs. Also, the processing unit 156 also adds information on the frequency which is not much affected by the disturbing signal to the control information. The terminal apparatus 14 broadcasts the data, using only the frequencies which are not much affected by the disturbing signals. According to this modification, the communication can be performed even through disturbing signals exist.

In the exemplary embodiments of the present invention, the frame generator 1160 specifies frames each of which is constituted by a plurality of slots. However, this should not be considered as limiting and, for example, the frame generator 1160 may provide periods (fields) other than the plurality of slots, in each frame. More specifically, a plurality of slots may be assigned in a partial period of a frame, whereas the CSMA/CA scheme may be used in communication between a plurality of terminal apparatuses 14 in the remaining periods. In such a case, the access control apparatus does not detect the empty slots and the collision slots while the CSMA/CA scheme is in use. According to this modification, each terminal apparatus 1014 can select the communication mode between a communication using slots and a communication using the CSMA/CA scheme. Hence, the degree of freedom in communications can be increased. In other words, it suffices that each frame at least contains a plurality of slots.

In the exemplary embodiments of the present invention, the control information broadcast from the access control apparatus 1010 and the data broadcast from a terminal apparatus 1014 are each assigned to a single slot. However, this should not be considered as limiting and, for example, the control information and the data may each be assigned to two or more slots. According to this modification, the transmission rate of control information and data can be increased.

In the exemplary embodiments of the present invention, an identification carrier is equivalent to two subcarriers. Also, the identification carrier is assigned to the subcarriers near the center frequency of an OFDM symbol. However, this should not be considered as limiting and, for example, the identification carrier may be equivalent to two or more subcarriers. For example, the identification carrier may be assigned to subcarriers other than those near the center frequency of an OFDM symbol. In such a case, the information on empty slots and the information on collision slots may be added to the identification carrier. According to this modification, the communication system 1100 can be designed more freely.

In the exemplary embodiments of the present invention, the first broadcast timing and the first stop timing are combined, the second broadcasting timing and the second stop timing are combined, and the third broadcasting timing and the third stop timing are combined. However, this should not be considered as limiting and, for example, any one of the broadcast timings and any one of the stop timings may be combined arbitrarily. According to this modification, the communication system 1100 can be designed more freely.

### DESCRIPTION OF THE REFERENCE NUMERALS

10 Access control apparatus
14 Terminal apparatus
50 Antenna
52 RF unit
54 Modem unit
56 Processing unit
58 Control unit
60 Timing identifying unit
62 Acquisition unit
64 Generator
66 Control information extraction unit
68 Slot decision unit
70 Notification unit
100 Communication system
150 Antenna
152 RF unit
154 Modem unit
156 Processing unit
158 GPS positioning unit
160 Frame generator
162 Control unit
164 Extraction unit
166 Identifying unit
168 Decision unit

### INDUSTRIAL APPLICABILITY

The present invention reduces the influence by disturbing signals.

1. An access control apparatus, comprising:
a processing unit configured to generate timing information on timing, with which each of radio apparatuses is to synchronize when the each of radio apparatus broadcasts a signal, to control the communication between the radio apparatuses;
a broadcasting unit configured to broadcast the timing information generated by said processing unit; and
a receiver configured to receive a signal used in the communication between the radio apparatuses, the signal being synchronous with the timing information broadcast by said broadcasting unit,
wherein when said receiver has received a signal which is asynchronous with the timing information and when the duration of said signal continues for a period longer than a first threshold value and the quality of said signal is more deteriorated than a second threshold value, said processing unit detects that the signal received by said receiver is a non-normal signal, and
wherein said broadcasting unit further broadcasts a detection result that the non-normal signal has been detected by said processing unit.

2. An access control apparatus according to claim 1, further comprising an estimation unit configured to estimate the degree of movement of a source of the signal, which is asynchronous with the timing information, received by said receiver,
wherein when said receiver has received the signal which is asynchronous with the timing information, when the duration of said signal continues for a period longer than the first threshold value and the quality of said signal is more deteriorated than the second threshold value and further when the degree of movement estimated by said estimation unit is smaller than a third threshold value, said processing unit detects that the signal received by said receiver is a non-normal signal.

3. An access control apparatus according to claim 1, wherein when the non-normal signal has been detected, said processing unit specifies a frequency band in which the influence of the non-normal signal is small, and
wherein said broadcasting unit further broadcasts information on the frequency band specified by said processing unit.

4. A broadcasting method, comprising:
broadcasting timing information on timing, with which each of radio apparatuses is to synchronize when the each of radio apparatus broadcasts a signal, to control the communication between the radio apparatuses;
receiving a signal used in the communication between the radio apparatuses, the signal being synchronous with the timing information broadcast by said broadcasting; and
detecting that the received signal is a non-normal signal, when a signal which is asynchronous with the timing information has been received and when the duration of said signal continues for a period longer than a first threshold value and the quality of said signal is more deteriorated than a second threshold value,
wherein said broadcasting further broadcasts a detection result that the disturbing non-normal signal has been detected.

5. A radio apparatus, comprising:
a communication unit configured to broadcast a signal containing a measured present position and configured to receive a signal containing a present position of another radio apparatus from another radio apparatus;
a measurement unit configured to measure a radio wave environment in said communication unit;
a storage control unit configured to store the measured position in a storage medium, when the radio wave environment measured by said measurement unit deteriorates; and
an identifying unit configured to identify timing with which the present position stored in the storage medium is to be broadcast,
wherein said communication unit broadcasts the signal containing the present position stored in the storage medium by said storage control unit, with the timing identified by said identifying unit.

6. A radio apparatus according to claim 5, wherein said identifying unit identifies, as the timing to be broadcast, timing when a predetermined time duration elapses after the timing with which said storage control unit has stored the position of location in the storage medium.

7. A radio apparatus according to claim 5, wherein said identifying unit identifies, as the timing to be broadcast, timing when a predetermined distance is moved after the timing with which said storage control unit has stored the position of location in the storage medium.

8. A radio apparatus according to claim 5, wherein said communication unit receives, from an access control apparatus for controlling communications between radio apparatuses, timing information with which the radio apparatuses are to synchronize when the radio apparatuses broadcast signal, and
said communication unit broadcasts the signals with timing based on the timing information, and
wherein said identifying unit identifies, as the timing to be broadcast, timing when timing information sent from a new access control apparatus is received.

9. An access control apparatus, comprising:
a processing unit configured to generate timing information on timing, with which each of radio apparatuses is to synchronize when the each of radio apparatus broadcasts a signal, to control the communication between the radio apparatuses;
a broadcasting unit configured to broadcast the timing information generated by said processing unit; and
a receiver configured to receive a signal broadcast from the radio apparatus according to the timing information broadcast by said broadcasting unit; and
an extraction unit configured to extract positional information, when the positional information on a position where a radio wave environment is deteriorated is contained in the signals received by said receiver,
wherein said broadcasting unit further broadcasts the positional information extracted by said extraction unit.
